(19) United States
(12) Patent Application Publication
(10) Pub. No.: US 2022/0305804 A1
(43) Pub. Date: Sep. 29, 2022

(54) PRINT CONDITION SETTING METHOD AND PRINT CONDITION SETTING SYSTEM

(71) Applicant: SEIKO EPSON CORPORATION, Tokyo (JP)

(72) Inventors: Mitsuhiro YAMASHITA, Matsumoto (JP); Takahiro KAMADA, Matsumoto (JP); Kenji MATSUZAKA, Shiojiri (JP); Satoru ONO, Shiojiri (JP); Ryoki WATANABE, Matsumoto (JP)

(21) Appl. No.: 17/656,246

(22) Filed: Mar. 24, 2022

(30) Foreign Application Priority Data
Mar. 26, 2021 (JP) 2021-052917

(51) Int. Cl. B41J 2/195

(52) U.S. Cl. CPC B41J 2/195

(57) ABSTRACT

A print condition setting method for setting a print condition in a printer includes: an ink type learning step of executing machine learning of an ink type discriminator using physical property information of ink and an ink type identifier; a medium type learning step of executing machine learning of a medium type discriminator using characteristic information of a medium and medium type identification information; and a print condition setting step of setting the print condition according to an ink type discriminated by the ink type discriminator and a medium type discriminated by the medium type discriminator.

The present application is based on, and claims priority from JP Application Serial Number 2021-052917, filed Mar. 26, 2021, the disclosure of which is hereby incorporated by reference herein in its entirety.

### BACKGROUND

### 1. Technical Field

The present disclosure relates to a print condition setting method and a print condition setting system.

### 2. Related Art

In the related art, JP-A-2005-231356 describes an ink discrimination method including: a step of irradiating filled ink with light; a step of measuring a light amount of the light transmitted through or reflected by the ink and measuring a plurality of light amounts of light having different wavelengths for ink of one color; and a step of discriminating whether the filled ink is predetermined ink based on the plurality of measured light amounts.

In the ink discrimination method described in JP-A-2005-231356, it is discriminated whether the ink is the predetermined ink to prevent a low image quality or a failure, and it is not possible to select a print condition according to the ink. A combination of the ink and a recording paper is not considered.

### SUMMARY

A print condition setting method is a print condition setting method for setting a print condition in a printer, the print condition setting method including: an ink type learning step of executing machine learning of an ink type discriminator using physical property information of ink and an ink type identifier; a medium type learning step of executing machine learning of a medium type discriminator using characteristic information of a medium and medium type identification information; and a print condition setting step of setting the print condition according to an ink type discriminated by the ink type discriminator and a medium type discriminated by the medium type discriminator.

A print condition setting system is a print condition setting system configured to set a print condition in a printer, the print condition setting system including: an ink type learning unit configured to execute machine learning of an ink type discriminator using physical property information of ink and an ink type identifier; a medium type learning unit configured to execute machine learning of a medium type discriminator using characteristic information of a medium and medium type identification information; and a print condition setting unit configured to set the print condition according to an ink type discriminated by the ink type discriminator and a medium type discriminated by the medium type discriminator.

### BRIEF DESCRIPTION OF THE DRAWINGS

FIG. 1 is a schematic diagram illustrating an example of a configuration of a printer.

FIG. 2 is a block diagram illustrating a configuration of a print condition setting system.

FIG. 3 is a flowchart illustrating a processing method of an ink type learning step.

FIG. 4 is a schematic diagram illustrating an example of a training model used in the ink type learning step.

FIG. 5 is an explanatory diagram illustrating an example of print conditions (control parameters).

FIG. 6 is an explanatory diagram illustrating an example of print conditions (maintenance modes).

FIG. 7 is an explanatory diagram illustrating an example of print conditions (ICC profiles).

FIG. 8 is a flowchart illustrating a processing method of an ink type discrimination step.

FIG. 9 is an explanatory diagram illustrating a configuration of a first machine learning model.

FIG. 10 is an explanatory diagram illustrating a configuration of a second machine learning model.

FIG. 11 is a flowchart illustrating a processing procedure of a medium type learning step.

FIG. 12 is an explanatory diagram illustrating a medium identifier list.

FIG. 13 is an explanatory diagram illustrating a medium and print setting table.

FIG. 14 is an explanatory diagram illustrating spectral data subjected to clustering processing.

FIG. 15 is an explanatory diagram illustrating a group management table.

FIG. 16 is an explanatory diagram illustrating a feature spectrum.

FIG. 17 is an explanatory diagram illustrating a configuration of a known feature spectrum group.

FIG. 18 is a flowchart illustrating a processing procedure of a medium type discrimination step.

FIG. 19 is a flowchart illustrating a processing procedure of medium addition processing.

FIG. 20 is an explanatory diagram illustrating a management state of a spectral data group.

FIG. 21 is an explanatory diagram illustrating a medium identifier list updated in response to addition of a print medium.

FIG. 22 is an explanatory diagram illustrating a group management table updated in response to addition of a print medium.

FIG. 23 is an explanatory diagram illustrating a group management table updated in response to addition of a machine learning model.

FIG. 24 is a flowchart illustrating a processing procedure of update processing of a machine learning model.

FIG. 25 is a flowchart illustrating a processing method of a print condition setting step.

FIG. 26 is an explanatory diagram illustrating an example of a print condition table.

### DESCRIPTION OF EXEMPLARY EMBODIMENTS

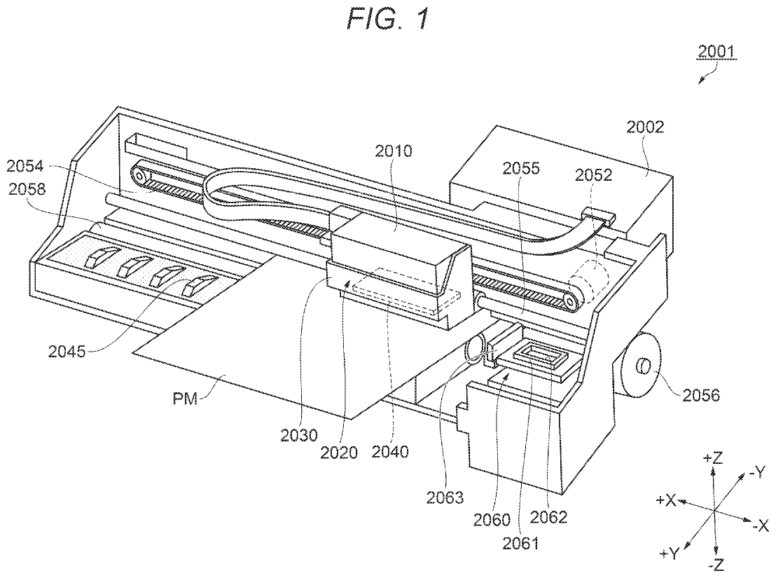

A print condition setting method according to the present embodiment for setting a print condition in a printer 2001 (FIG. 1) includes: an ink type learning step (step S10 [not illustrated]) of executing machine learning of an ink type discriminator using physical property information of ink and an ink type identifier; a medium type learning step (step S30 [not illustrated]) of executing machine learning of a medium type discriminator using characteristic information of a medium and medium type identification information; and a print condition setting step (step S50 [not illustrated]) of setting a print condition according to an ink type discriminated by the ink type discriminator and a medium type discriminated by the medium type discriminator. Further, the print condition setting method includes an ink type discriminating step (step S20 [not illustrated]) and a medium type discriminating step (step S40 [not illustrated]).

The machine learning method of the ink type discriminator and the machine learning method of the medium type discriminator described above are executed according to different methods. In detail, in the ink type learning step (step S10), one machine learning model (a training model 105) is provided, and in the medium type learning step (step S30), a plurality of (two in the present embodiment) machine learning models 201 and 202 are provided. By adopting a learning method suitable for a target of the machine learning, the processing can be efficiently executed.

The processing of the ink type learning step (step S10), the ink type discriminating step (step S20), the medium type learning step (step S30), and the medium type discriminating step (step S40) may not necessarily be uniformly executed in parallel, and the number of processing times and processing timing of the steps can be appropriately processed.

FIG. 1 is a schematic diagram illustrating a configuration example of the printer 2001. The printer 2001 is an inkjet printer capable of executing printing on a print medium PM (for example, paper) serving as a medium.

The printer 2001 includes a carriage 2020. The carriage 2020 includes a mounting portion 2030 and a head 2040.

The mounting portion 2030 is configured such that cartridge 2010 capable of containing ink as a liquid can be attached to and detached from the mounting portion 2030. The number of cartridges 2010 mounted on the mounting portion 2030 may be single or plural.

The cartridge 2010 is mounted on the mounting portion 2030 in a state of being inserted into a liquid introduction needle (not illustrated) provided at the mounting portion 2030. The ink contained in the cartridge 2010 is supplied to the head 2040 via the liquid introduction needle.

The head 2040 includes a plurality of nozzles (not illustrated), and ejects the ink as droplets from the nozzles. The head 2040 includes, for example, a piezo element as an ink ejection mechanism, and the piezo element drives the ink to eject the ink from the nozzles. By ejecting the ink from the head 2040 to the print medium PM supported by platens 2045, characters, figures, images, and the like are printed on the print medium PM.

The printer 2001 includes a main scanning feeding mechanism and a sub scanning feeding mechanism that move the carriage 2020 and the print medium PM relative to each other. The main scanning feeding mechanism includes a carriage motor 2052 and a drive belt 2054. The carriage 2020 is fixed to the drive belt 2054. By the power of the carriage motor 2052, the carriage 2020 is guided by a suspended guide rod 2055 to reciprocate in a direction along an X axis. The sub scanning feeding mechanism includes a conveyance motor 2056 and a conveyance roller 2058, and conveys the print medium PM in a +Y direction by transmitting the power of the conveyance motor 2056 to the conveyance roller 2058. The direction in which the carriage 2020 reciprocates is a main scanning direction, and the direction in which the print medium PM is conveyed is a sub scanning direction.

The printer 2001 includes the platens 2045, and a heating unit that heats the print medium PM to be conveyed may be disposed at conveyance paths upstream and downstream of the conveyance path of the platens 2045.

The printer 2001 includes a maintenance unit 2060. The maintenance unit 2060 performs, for example, various types of maintenance on the head 2040. For example, the maintenance unit 2060 includes a capping unit 2061. The capping unit 2061 includes a cap 2062 having a recess. The capping unit 2061 is provided with an elevation mechanism including a drive motor (not illustrated), and can move the cap 2062 in a direction along a Z axis. When the printer 2001 is not in operation, the maintenance unit 2060 caps a region in which the nozzles are formed by bringing the cap 2062 into close contact with the head 2040, thereby preventing problems such as clogging of the nozzles due to drying of the ink.

The maintenance unit 2060 has various functions of cleaning the nozzles. For example, when ink is not ejected from the nozzles for a long period of time or a foreign matter such as paper dust adheres to the nozzles, the nozzles may be clogged. When the nozzles are clogged, a phenomenon that ink is not ejected when ink is to be ejected from the nozzles and ink dots are not formed at positions where the ink dots are to be formed, that is, nozzle omission occurs. When the nozzle omission occurs, the image quality becomes low. Therefore, the maintenance unit 2060 forcibly ejects the ink from the nozzles toward the recess of the cap 2062. That is, the nozzles are cleaned by performing flushing. Accordingly, an ejection state of the nozzles can be recovered to a good state.

In addition to the above, the maintenance unit 2060 includes a wiping unit 2063 that wipes a nozzle surface, a nozzle inspecting unit that inspects the state of the nozzles, and the like.

The printer 2001 includes a control unit 2002. The carriage motor 2052, the conveyance motor 2056, the head 2040, the maintenance unit 2060, and the like are controlled based on control signals from the control unit 2002.

The printer 2001 includes a general-purpose interface such as a LAN interface or a USB interface, and can communicate with various external devices.

In the print condition setting method according to the present embodiment, a print condition suitable for the ink to be used in the printer 2001 and the print medium PM to be used is set using machine learning.

Specific descriptions will be given below.

First, the ink type learning step (step S10) will be described.

In the ink type learning step (step S10), an ink type discriminator 102 serving as a learned model (learned ink) is generated by machine learning using teaching data 104 in which ink characteristic data which is the physical property information of the ink is associated with attribute information of the ink including the ink type identifier.

Next, the generation processing of the ink type discriminator 102 will be described in detail.

The ink is the ink to be used in the printer 2001. The apparatus in which the ink is used is not limited to the printer 2001, and may be, for example, a drawing apparatus, a painting apparatus, a writing apparatus, or the like.

The attribute information of the ink including the ink type identifier is information of at least one of a color of the ink, a type of the ink, a component contained in the ink, a manufacturer of the ink, a manufacturing region of the ink, and a manufacturing time of the ink, in addition to the information of the type of the ink, that is, an ink name (a manufacturer name) and an ink product number.

Examples of the type of the ink include information such as water-based, oil-based, ultraviolet curable, thermosetting, dye-based, and pigment-based.

The ink characteristic data is data of at least one of absorbance A, transmittance T %, and reflectance R % that are observed by irradiating the ink with light.

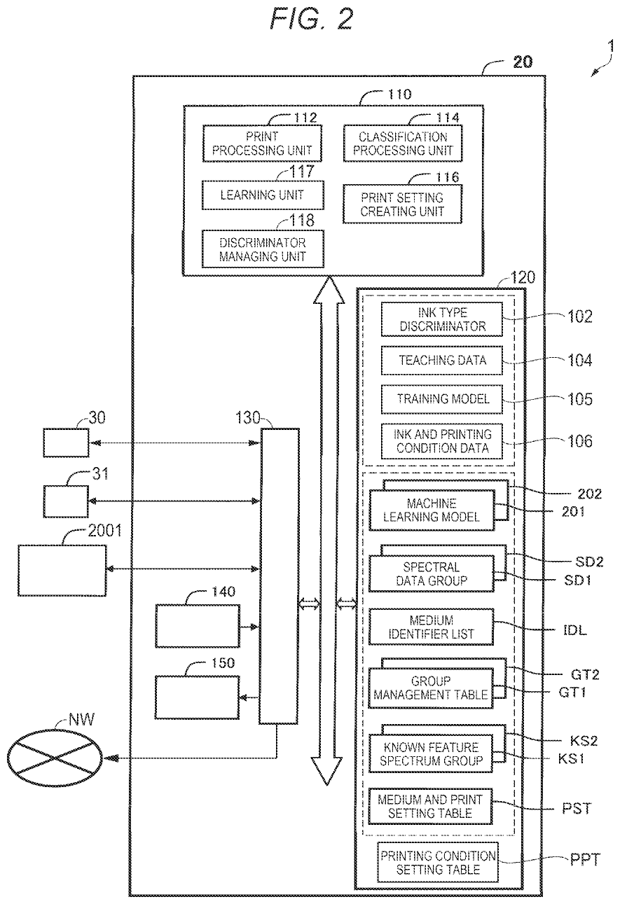

The ink type discriminator 102 is generated by training the training model 105 using the teaching data 104 in the print condition setting system 1 illustrated in FIG. 2. The ink type discriminator 102 is a discrimination program using a learned model acquired by training the training model 105 according to the teaching data 104 acquired up to a certain point in time.

The print condition setting system 1 is a print condition setting system that sets a print condition in the printer 2001. The print condition setting system 1 includes an ink type learning unit that executes machine learning of an ink type discriminator using physical property information of ink and an ink type identifier, a medium type learning unit that executes machine learning of a medium type discriminator using characteristic information of a medium and medium type identification information, and a print condition setting unit that sets the print condition according to an ink type discriminated by the ink type discriminator and a medium type discriminated by the medium type discriminator.

The print condition setting system 1 includes an information processing apparatus 20, a spectral analyzer 30, and the like.

The information processing apparatus 20 is a computer system, and includes a calculation unit 110, an input unit 140, a display unit 150, a storage unit 120, a communication unit 130, and the like.

The calculation unit 110 is provided with the ink type learning unit, the medium type learning unit, and the print condition setting unit described above. The calculation unit 110 includes a print processing unit 112 that executes print processing using the printer 2001.

The information processing apparatus 20 is preferably a notebook PC which is easy to carry. The print medium PM also includes a roll medium in which a print medium is wound around a roll-shaped core material. In the present embodiment, printing is described as an example of recording, and the present disclosure can be applied to a recording system, an apparatus, and a method in a broad sense including fixing in which recording conditions need to be changed according to physical information of the medium.

The calculation unit 110 includes a CPU, a RAM, and a ROM, and executes calculation necessary for machine learning according to a program stored in the storage unit 120. In order to execute machine learning, the calculation unit 110 includes a GPU or various processors designed for machine learning.

The CPU means a central processing unit, the RAM means a random access memory, the ROM means a read-only memory, and the GPU means a graphics processing unit.

The input unit 140 is information input unit serving as a user interface. Specifically, the input unit 140 is, for example, a keyboard, a mouse pointer, or the like.

The display unit 150 is information display unit serving as a user interface, and displays, for example, information input by the input unit 140 and a calculation result of the calculation unit 110 based on control of the calculation unit 110.

The storage unit 120 is a rewritable storage medium such as a hard disk drive or a memory card, and stores a learning program according to which the calculation unit 110 operates, the teaching data 104 for executing machine learning, the training model 105, the ink type discriminator 102 serving as a learned model generated as a result of machine learning, various calculation programs according to which the calculation unit 110 operates, and the like.

The communication unit 130 includes, for example, a general-purpose interface such as a LAN interface or a USB interface, and is coupled to external electronic devices, for example, the spectral analyzer 30, the printer 2001, or a network NW to exchange information with these devices. The network NW is also coupled to a cloud environment.

In the above description, the printer 2001, the information processing apparatus 20, and the spectral analyzer 30 are described as independent configurations. The present disclosure is not limited to these configurations, and may be any configuration having these functions.

In the present embodiment, the print condition setting system 1 executes machine learning using the training model 105 and using the ink characteristic data of various types of ink and the information of the types of the ink corresponding to the ink characteristic data as the teaching data 104. The information of the types of the ink is the types of ink or the attribute information of the ink including the types of the ink.

Data such as the absorbance A, the transmittance T %, and the reflectance R % that are acquired by the spectral analysis of the ink is used as the ink characteristic data since it is possible to take advantage of a fact that these characteristics are different depending on the types of the ink.

The absorbance A, the transmittance T %, and the reflectance R % of the ink are acquired by evaluating, using the spectral analyzer 30, an intensity of light absorbed by the ink, an intensity of light transmitted through the ink, and an intensity of light reflected by the ink with respect to an intensity of light with which an ink sample is irradiated.

When the intensity of the incident light is denoted by I0, the intensity of the transmitted light is denoted by I1, and the intensity of the reflected light is denoted by I2, the intensities are obtained as follows.

Absorbance A=log(I0/I1)

Transmittance T %=I1/I0×100

Reflectance R %=I2/I0×100

In the spectral analysis, a wavelength of the light with which the sample is irradiated is divided into a predetermined wavelength range, for example, from an ultraviolet region to an infrared region at intervals of 10 nm, and is acquired as a set of data of the absorbance A, the transmittance T %, and the reflectance R % in the wavelength range.

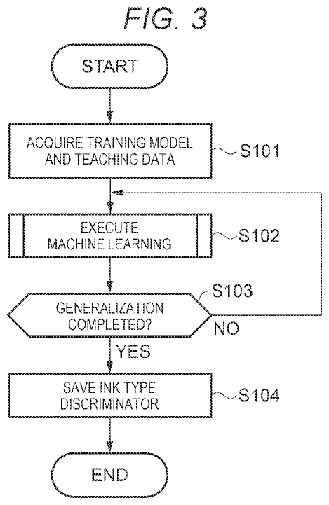

FIG. 3 is a flowchart illustrating a detailed processing method in the ink type learning step (step S10). Specifically, the flowchart illustrates processing in which the calculation unit 110 executes machine learning to generate the ink type discriminator 102. Before the processing is started, the ink characteristic data of a plurality of types of ink is collected as the teaching data 104 associated with the types of the ink or the attribute information of the ink including the types of the ink, and is stored in the storage unit 120.

First, in step S101, the training model 105 and the teaching data 104 are acquired from the storage unit 120.

Next, in steps S102 and S103, the machine learning processing using the training model 105 is executed until generalization is completed. The determination in step S103 whether the generalization of the training model 105 is completed is executed by determining a threshold value of a correct answer rate of an output acquired by inputting test data to the training model 105 up to that point in time.

When generalization is completed by giving the teaching data 104 to the training model 105 and executing machine learning, the ink type discriminator 102 is generated. In step S104, the ink type discriminator 102 is saved in the storage unit 120 as a learned model.

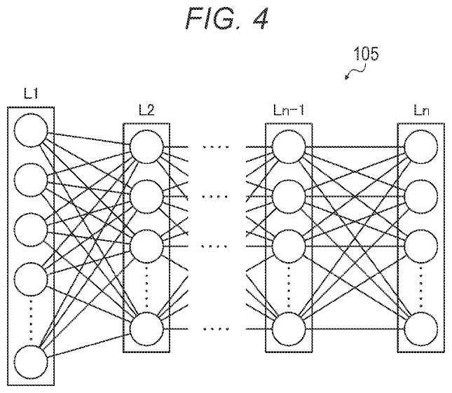

The training model 105 for machine learning can be defined in various ways. FIG. 4 is a diagram schematically illustrating an example of the training model 105 used in the present embodiment. In this figure, each layer of all n layers according to CNN is denoted by L1 to Ln, and nodes of a normal neural network are denoted by white circles. In the present embodiment, the CNN is used. Alternatively, other models such as various neural networks such as a capsule network and a vector neural network may be used. The CNN means a convolutional neural network.

The first layer L1 is provided with a plurality of nodes for inputting ink characteristic data for each constant wavelength. In the present embodiment, for example, the reflectance R % for each constant wavelength indicated by spectral reflectance data is input data to each node of the first layer L1 which is the input layer, and the final output data corresponding to the reflectance R % is output from the final output layer Ln.

Instead of or in addition to the data of the reflectance R %, the transmittance T % or the absorbance A for each constant wavelength may also be used. For example, when three pieces of data of the absorbance A, the transmittance T %, and the reflectance R % are used, three training models 105 may be provided, results corresponding to the absorbance A, the transmittance T %, and the reflectance R % may be output from the final layer of each training model 105, and the final output layer Ln for integrating and determining the results may be constructed to output a final result.

Among the attribute information of the ink, information that may affect tendency of the ink characteristic data determined according to the type of the ink may be received from a newly provided node as the input data.

An output of each node of the first layer L1 is connected to a node of the next second layer L2 with a predetermined weighting applied thereto. The same applies from the second layer L2 to the (Ln−1)th layer. By repeating an operation of correcting the weighting between the nodes in the layers using the teaching data 104, the learning proceeds, and the ink type discriminator 102 using the learned model is generated.

The storage unit 120 stores ink and print condition data 106.

The ink and print condition data 106 according to the present embodiment includes print conditions that can be set for the printer 2001, and is table data in which the learned ink (the ink type) is associated with a print condition corresponding to the learned ink. The print condition according to the present embodiment includes at least one of a control parameter, a maintenance mode, an ICC profile, and a print mode of the printer 2001.

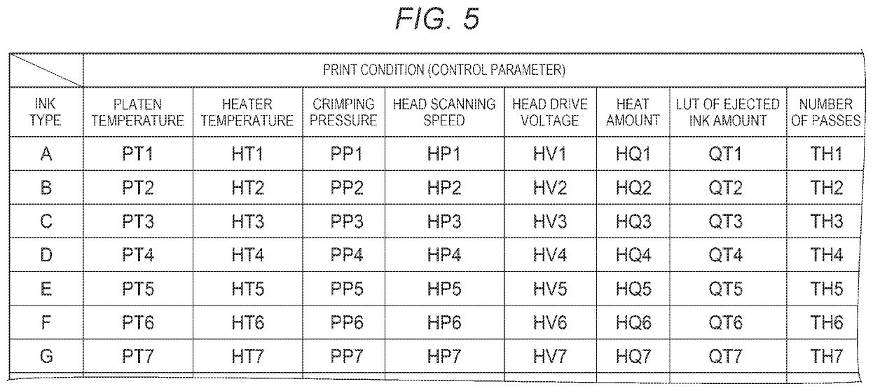

As illustrated in FIG. 5, the control parameter includes, in addition to a temperature of the platen 2045, an after-heater temperature for heating the conveyance path downstream of the conveyance path of the platen 2045, and a pre-heater temperature for heating the conveyance path upstream of the conveyance path of the platen 2045, at least one of a crimping pressure (a nip pressure of the conveyance roller 2058), a scanning speed of the head 2040, a drive voltage of the head 2040, a heat amount (a heating amount of the head 2040), a LUT of an ejected ink amount, and the number of passes.

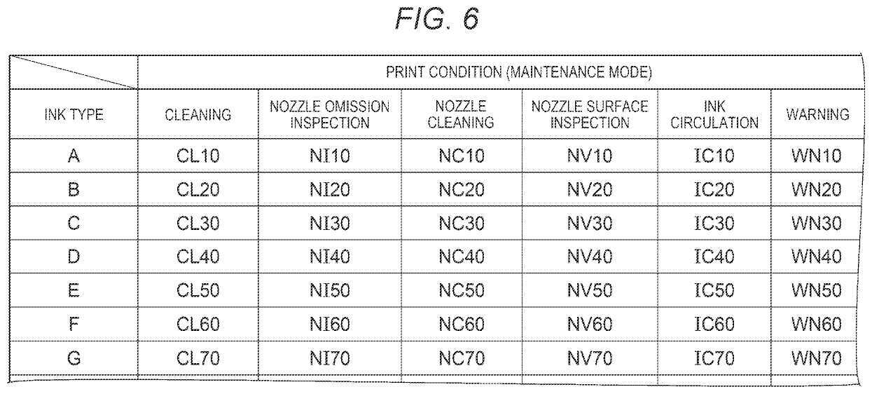

As illustrated in FIG. 6, the maintenance mode includes at least one of a cleaning frequency of the head 2040, a nozzle omission inspection frequency, an automatic cleaning frequency of a nozzle surface, an inspection frequency of the nozzle surface, a warning frequency, and an ink circulation frequency.

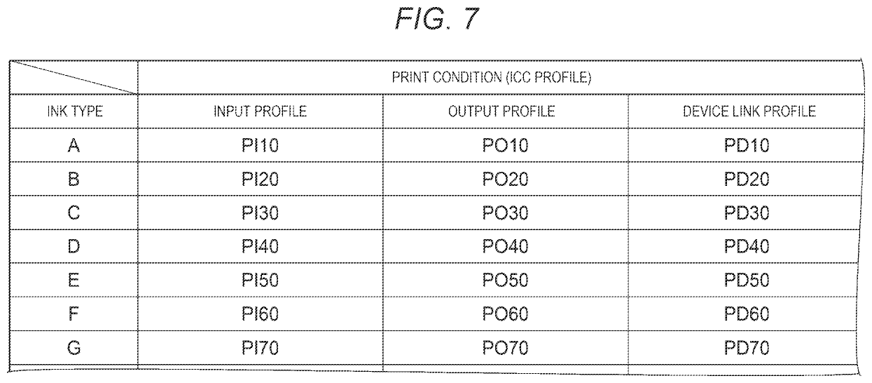

As illustrated in FIG. 7, the ICC profile includes at least one of an input profile, an output profile, and a device link profile. The ICC profile is a series of data characterizing input and output devices related to colors or a color space according to standards published by International Color Consortium in color management. The input profile is conversion data of an input device such as a camera or a display, the output profile is conversion data of an output device such as the printer 2001, and the device link profile is conversion data in which the input device is associated with the output device.

The print mode includes at least one of a print resolution, the number of passes, a type of halftone, an ink dot arrangement, and an ink dot size.

The spectral analyzer 30 includes a spectral analysis unit, a communication unit, and the like.

The spectral analyzer 30 includes a light source, a spectrometer, a detector, and the like, and can acquire at least one piece of ink observation data among the absorbance A, the transmittance T %, and the reflectance R % that are observed by irradiating the ink with light.

Next, the ink type discrimination step (step S20) will be described.

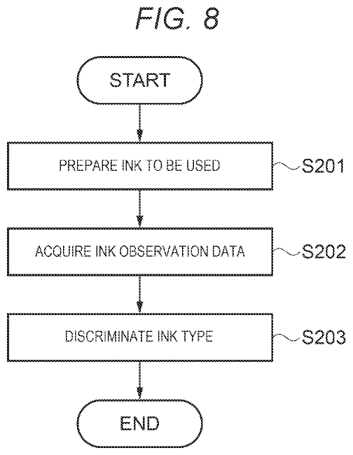

FIG. 8 is a flowchart illustrating a detailed processing method in the ink type discrimination step (step S20).

When the ink discrimination processing is started, the information processing apparatus 20 includes the ink type discriminator 102 as a learned model in the storage unit 120. That is, in the present embodiment, the ink type discriminator 102 is generated in advance by machine learning using the teaching data 104 in which at least one piece of the ink characteristic data among the absorbance A, the transmittance T %, and the reflectance R % observed by irradiating the ink with light is associated with the types of the ink or the attribute information of the ink including the types of the ink.

First, in step S201, an ink sample to be used in the printer 2001 is prepared. Specifically, the ink sample to be used is set in the spectral analyzer 30 in a state in which the sample can be analyzed.

Next, in step S202, the spectral analysis of the ink sample is executed by the spectral analyzer 30 to acquire the ink observation data. In the spectral analysis, a wavelength of the light with which the sample is irradiated is divided into a predetermined wavelength range, for example, from an ultraviolet region to an infrared region at intervals of 10 nm, and is acquired as a set of data of the absorbance A, the transmittance T %, and the reflectance R % in the wavelength range.

The spectral analyzer 30 transmits the acquired ink observation data to the information processing apparatus 20 via the communication unit.

Next, in step S203, the information processing apparatus 20 that receives the ink observation data inputs the ink observation data to the ink type discriminator 102 in the calculation unit 110, and discriminates the type of the ink based on the output data of the ink type discriminator 102. In the discrimination of the type of the ink, a similarity may be calculated, and the ink type may be discriminated according to the similarity.

The similarity is calculated according to the following equation (1) using a color difference (ΔE) between the learned ink types.

Similarity=1.0−ΔE/Range (1)

When the similarity <−1.0, the similarity=−1.0. Range is a value that can be appropriately adjusted.

Here, the similarity is calculated as a value of −1.0 or more and 1.0 or less. Further, it is determined that, as the similarity is closer to 1.0, the similarity of the ink to be used to the ink to be learned is higher. On the other hand, it is determined that, as the similarity is closer to −1.0, the similarity of the ink to be used to the ink to be learned is lower.

Here, for example, the ink having the highest similarity among the types of ink to be used is determined as the ink type.

Next, the processing methods of the medium type learning step (step S30) and the medium type discrimination step (step S40) will be described.

As illustrated in FIG. 2, the spectral analyzer 31 can execute spectral measurement on the print medium PM serving as the medium used in the printer 2001 in an unprinted state to acquire a spectral reflectance as the characteristic information of the medium. In the present disclosure, the spectral reflectance serving as the characteristic information of the medium is also referred to as “spectral data”. The spectral analyzer 31 includes, for example, a wavelength variable interference spectral filter and a monochrome image sensor. The spectral data acquired by the spectral analyzer 31 is used as the input data to a machine learning model to be described later. As will be described later, the information processing apparatus 20 executes classification processing of spectral data using the machine learning model, and classifies which of a plurality of classes the print medium PM corresponds to. The “class of the print medium PM” means the type of the print medium PM.

The calculation unit 110 functions as a classification processing unit 114 that executes the classification processing of spectral data of the print medium PM, and also functions as a print setting creating unit 116 that creates a print setting suitable for the print medium PM. Furthermore, the calculation unit 110 also functions as a learning unit 117 that acquires a discriminator, and also functions as a discriminator managing unit 118 that manages information related to the discriminator. The discriminator executes machine learning using physical information and type information of the print medium PM. The discriminator will be described later.

The classification processing unit 114, the print setting creating unit 116, the learning unit 117, and the discriminator managing unit 118 are achieved by the calculation unit 110 executing the program stored in the storage unit 120. In a preferred example, one or a plurality of the calculation units 110 are provided. These units may be achieved by a hardware circuit. The calculation unit 110 according to the present embodiment is a term also including such a hardware circuit.

The calculation unit 110 that executes the classification processing may be a processor provided in a remote computer coupled to the information processing apparatus 20 via a network NW including a cloud environment.

The storage unit 120 stores a plurality of machine learning models 201 and 202 (medium type discriminators), a plurality of spectral data groups SD1 and SD2, a medium identifier list IDL (medium type identification information), a plurality of group management tables GT1 and GT2, a plurality of known feature spectrum groups KS1 and KS2, and a medium and print setting table PST. The machine learning models 201 and 202 are used for calculation executed by the classification processing unit 114. Configuration examples and operations of the machine learning models 201 and 202 will be described later. The spectral data groups SD1 and SD2 are sets of labeled spectral data used for learning of the machine learning models 201 and 202. The medium identifier list IDL is a list in which a medium identifier and spectral data are registered for each print medium. The plurality of group management tables GT1 and GT2 are tables indicating management states of the spectral data groups SD1 and SD2. The known feature spectrum groups KS1 and KS2 are sets of feature spectra acquired when teaching data is reinput to the learned machine learning models 201 and 202. The feature spectrum will be described later. The medium and print setting table PST is a table in which print settings (print conditions) suitable for each print medium are registered.

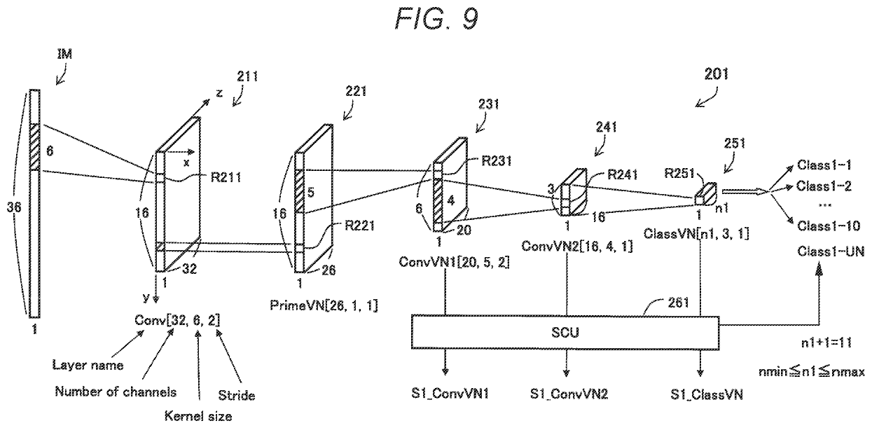

FIG. 9 is an explanatory diagram illustrating a configuration of a first machine learning model 201. The machine learning model 201 includes, in order from an input data IM side, a convolutional layer 211, a primary vector neuron layer 221, a first convolutional vector neuron layer 231, a second convolutional vector neuron layer 241, and a classification vector neuron layer 251. Among the five layers 211 to 251, the convolutional layer 211 is the lowest layer, and the classification vector neuron layer 251 is the highest layer. In the following description, the layers 211 to 251 are also referred to as a “Cony layer 211”, a “PrimeVN layer 221”, a “ConvVN1 layer 231”, a “ConvVN2 layer 241”, and a “ClassVN layer 251”, respectively.

In the present embodiment, the input data IM is spectral data, and thus is data in a one-dimensional array. For example, the input data IM is data acquired by extracting 36 representative values every 10 nm from spectral data in a range of 380 nm to 730 nm.

Two convolutional vector neuron layers 231 and 241 are used in the example in FIG. 9. Alternatively, the number of convolutional vector neuron layers may be any number, and the convolutional vector neuron layers may be omitted. It is preferable to use one or more convolutional vector neuron layers.

The machine learning model 201 in FIG. 9 further includes a similarity calculation unit 261 that generates a similarity. The similarity calculation unit 261 can calculate similarities S1_ConvVN1, S1_ConvVN2, and S1_ClassVN, which will be described later, based on outputs of the ConvVN1 layer 231, the ConvVN2 layer 241, and the ClassVN layer 251, respectively. Alternatively, the similarity calculation unit 261 may be omitted.

Configurations of the layers 211 to 251 can be described as follows.

### Descriptions of Configurations of First Machine Learning Model 201

Conv layer 211: Conv[32, 6, 2]

PrimeVN layer 221: PrimeVN[26, 1, 1]

ConvVN1 layer 231: ConvVN1[20, 5, 2]

ConvVN2 layer 241: ConvVN2[16, 4, 1]

ClassVN layer 251: ClassVN[n1, 3, 1]

Vector dimension VD: VD=16

In the descriptions of the layers 211 to 251, character strings before parentheses are layer names, and numbers in the parentheses are the numbers of channels, kernel sizes, and strides in order. For example, the layer name of the Conv layer 211 is “Conv”, the number of channels is 32, the kernel size is 1×6, and the stride is 2. In FIG. 9, these descriptions are illustrated below the layers. A hatched rectangle drawn in each layer represents a kernel used when an output vector of an adjacent upper layer is calculated. In the present embodiment, since the input data IM is data in a one-dimensional array, the kernel also has a one-dimensional array. Values of parameters used in the descriptions of the layers 211 to 251 are examples, and can be changed to any value.

The Conv layer 211 is a layer including scalar neurons. The other four layers 221 to 251 are layers including vector neurons. The vector neuron is a neuron in which a vector is used as an input or an output. In the above descriptions, the dimension of the output vector of each vector neuron is constant at 16. Hereinafter, a term “node” is used as a superordinate concept of the scalar neuron and the vector neuron.

In FIG. 9, regarding the Conv layer 211, a first axis x and a second axis y that define plane coordinates of node arrays, and a third axis z representing a depth are illustrated. FIG. 9 illustrates that the sizes of the Conv layer 211 in x, y, and z directions are 1, 16, and 32. The size in the x direction and the size in the y direction are referred to as “resolution”. In the present embodiment, the resolution in the x direction is always 1. The size in the z direction is the number of channels. These three axes x, y, and z are also used as coordinate axes indicating the positions of the nodes in the other layers. However, in FIG. 9, the axes x, y, and z are not illustrated in the layers other than the Conv layer 211.

As is well known, a resolution W1 in the y direction after convolution is acquired according to the following equation.

W1=Ceil{(W0−Wk+1)/S}

Here, W0 is the resolution before convolution, Wk is the kernel size, S is the stride, and Ceil{X} is a function for executing an operation of rounding up X.

The resolution of each layer illustrated in FIG. 9 is an example in which the resolution of the input data IM in the y direction is 36, and the actual resolution of each layer is appropriately changed according to the size of the input data IM.

The ClassVN layer 251 has n1 channels. The similarity calculation unit 261 has one channel. In the example in FIG. 9, (n1+1)=11. Determination values Class 1-1 to Class 1-10 for a plurality of known classes are output from the channels of the ClassVN layer 251, and a determination value Class 1-UN indicating an unknown class is output from the channel of the similarity calculation unit 261. The class having the largest value among the determination values Class 1-1 to Class 1-10 and Class 1-UN corresponds to the class to which the input data IM belongs. In general, n1 is an integer of 2 or more, and is the number of known classes that can be classified using the first machine learning model 201. In any machine learning model, an upper limit value nmax and a lower limit value nmin are preferably set in advance for the number of known classes that can be classified.

The determination value Class 1-UN indicating the unknown class may be omitted. In this case, when the largest value among the determination values Class 1-1 to Class 1-10 for the known classes is less than a predetermined threshold value, it is determined that the class of the input data IM is unknown.

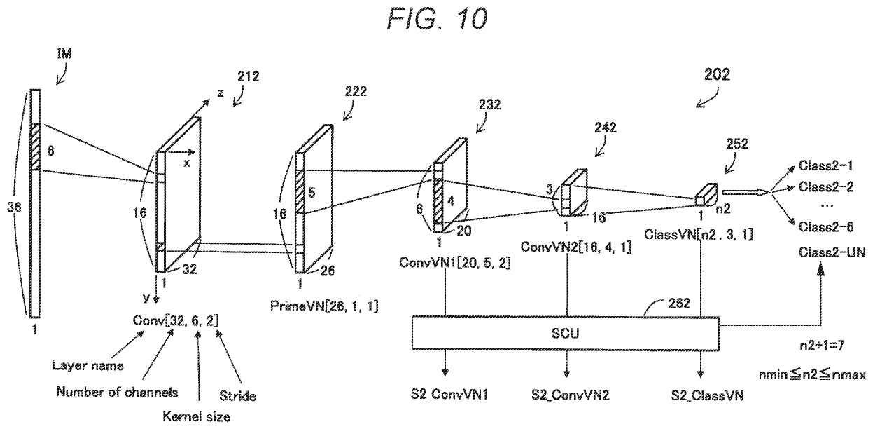

FIG. 10 is an explanatory diagram illustrating a configuration of a second machine learning model 202. Similarly to the first machine learning model 201, the machine learning model 202 includes a Conv layer 212, a PrimeVN layer 222, a ConvVN1 layer 232, a ConvVN2 layer 242, a ClassVN layer 252, and a similarity calculation unit 262.

The configurations of the layers 212 to 252 can be described as follows.

### Descriptions of Configurations of Second Machine Learning Model 202

Conv layer 212: Conv[32, 6, 2]

PrimeVN layer 222: PrimeVN[26, 1, 1]

ConvVN1 layer 232: ConvVN1[20, 5, 2]

ConvVN2 layer 242: ConvVN2[16, 4, 1]

ClassVN layer 252: ClassVN[n2, 3, 1]

Vector dimension VD: VD=16

As can be understood by comparing FIG. 9 and FIG. 10, among the layers 212 to 252 of the second machine learning model 202, the lower four layers 212 to 242 have the same configurations as the layers 211 to 241 of the first machine learning model 201. On the other hand, the uppermost layer 252 of the second machine learning model 202 is different from the uppermost layer 251 of the first machine learning model 201 only in the number of channels. In the example in FIG. 10, the ClassVN layer 252 has n2 channels, the similarity calculation unit 262 has one channel, and (n2+1)=7. Determination values Class 2-1 to Class 2-6 for a plurality of known classes are output from the channels of the ClassVN layer 252, and a determination value Class 2-UN indicating an unknown class is output from the channel of the similarity calculation unit 262. Also in the second machine learning model 202, the same upper limit value nmax and lower limit value nmin as those of the first machine learning model 201 are preferably set for the number of known classes.

The second machine learning model 202 has at least one known class different from that of the first machine learning model 201. Since the first machine learning model 201 and the second machine learning model 202 have different classes that can be classified, values of elements of the kernel are also different from each other. In the present disclosure, when N is an integer of 2 or more, any one of N machine learning models has at least one known class different from those of the other machine learning models. In the present embodiment, the number N of machine learning models is two or more, and the present disclosure can be applied to a case in which only one machine learning model is used.

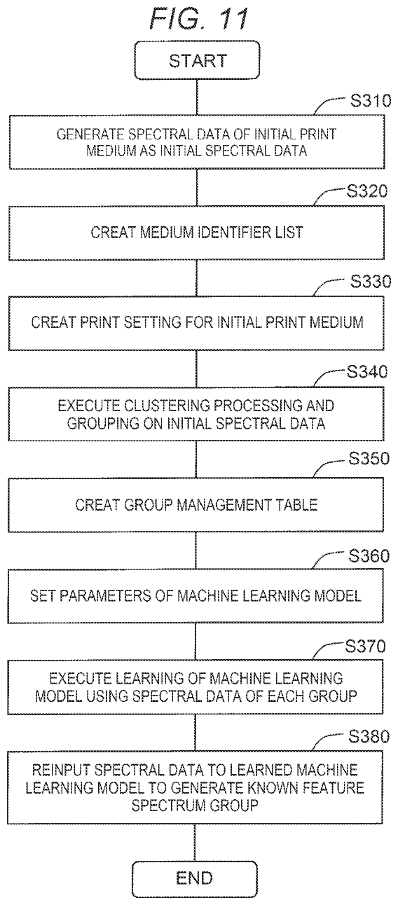

FIG. 11 is a flowchart illustrating a processing procedure of a preparation step of a machine learning model in the medium type learning step (step S30). The preparation step is, for example, a step executed by a manufacturer of the printer 2001.

In step S310, spectral data of a plurality of initial print media is generated as initial spectral data. In the present embodiment, all the initial print media used for learning of the machine learning model in the preparation step are any print medium. In the present disclosure, the “any print medium” is a print medium that can be a target of the classification processing executed by the machine learning model, and is a print medium that can be excluded from the target of the classification processing even when there is no exclusion instruction from a user. On the other hand, the print medium to be added in the medium addition processing to be described later is an essential print medium that cannot be excluded from the target of the classification processing unless there is an exclusion instruction from a user. Alternatively, a part or all of the initial print media may be used as the essential print medium.

In step S310, initial spectral data is generated by executing spectral measurement on the plurality of initial print media by the spectral analyzer 31 in the unprinted state. At this time, it is preferable to execute data expansion in consideration of variations in spectral reflectance. In general, the spectral reflectance varies depending on a colorimetric date or a measurement instrument. The data expansion is processing of generating a plurality of pieces of spectral data by giving random variations to measured spectral data in order to simulate such variations. The initial spectral data may be virtually generated without executing actual spectral measurement of the print medium. In this case, the initial print medium is also virtual.

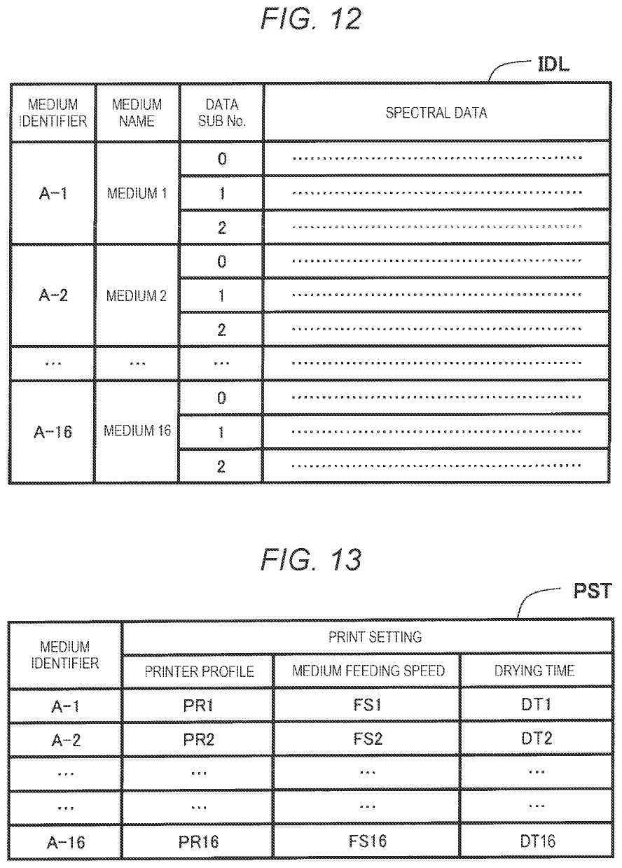

In step S320, a medium identifier list IDL is created for the plurality of initial print media. FIG. 12 is an explanatory diagram illustrating the medium identifier list IDL. In the medium identifier list IDL, a medium identifier, a medium name, a data sub-number, and spectral data that are given to each print medium are registered. In this example, medium identifiers “A-1” to “A-16” are assigned to 16 print media. The medium name is a name of a print medium displayed in a window for a user to set a print condition. The data sub-number is a number for distinguishing a plurality of pieces of spectral data relating to the same print medium. In this example, three pieces of spectral data are registered for each print medium. Alternatively, the number of spectral data for each print medium may be different. For each print medium, one or more pieces of spectral data may be registered, and it is preferable that a plurality of pieces of spectral data are registered.

In step S330 in FIG. 11, print settings are created for a plurality of initial print media, and are registered in the medium and print setting table PST. FIG. 13 is an explanatory diagram illustrating the medium and print setting table PST. In the records of the medium and print setting table PST, the medium identifier and the print settings (the print conditions) are registered for each print medium. In this example, printer profiles PR1 to PR16, medium feeding speeds FS1 to FS16, and drying times DT1 to DT16 are registered as the print settings. The medium feeding speeds FS1 to FS16 and the drying times DT1 to DT16 are a part of the above-described print conditions. The printer profiles PR1 to PR16 are output profiles of the printer 2001, and are created for each ink type and each print medium. Specifically, a test chart is printed on a print medium without color correction using the printer 2001, the test chart is subjected to the spectral measurement by the spectral analyzer 31, and the print setting creating unit 116 processes a spectral measurement result. Accordingly, the printer profile can be created. The medium feeding speeds FS1 to FS16 and the drying times DT1 to DT16 can also be experimentally determined. The “drying time” is a time for drying a print medium after printing in a dryer (not illustrated) in the printer 2001. In a printer in which drying is performed by blowing air to a print medium after printing, the “drying time” is an air blowing time. In a printer without a dryer, the “drying time” is a waiting time for natural drying. Initial items other than these items may be set as the print settings. For example, it is preferable that the initial items include any one of the control parameter, the maintenance mode, the ICC profile, and the print mode.

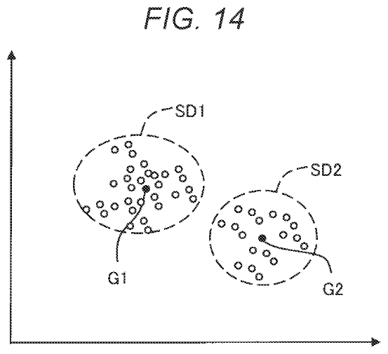

In step S340 in FIG. 11, grouping is executed by executing clustering processing on a plurality of pieces of initial spectral data for a plurality of initial print media. FIG. 14 is an explanatory diagram illustrating spectral data grouped by the clustering processing. In this example, a plurality of pieces of spectral data are grouped into a first spectral data group SD1 and a second spectral data group SD2. The clustering processing can be executed using, for example, a k-means method. The spectral data groups SD1 and SD2 have representative points G1 and G2 representing centers of the spectral data groups SD1 and SD2, respectively. The representative points G1 and G2 are, for example, centers of gravity. When the spectral data is reflectances at m wavelengths, it is possible to calculate a distance between the pieces of spectral data and the center of gravity of the plurality of pieces of spectral data by capturing one piece of spectral data as data representing one point in an m-dimensional space. In FIG. 14, for convenience of illustration, a plurality of points of spectral data are drawn in a two-dimensional space. Alternatively, in practice, the spectral data can be expressed as points in the m-dimensional space. As described later, these representative points G1 and G2 are used to determine, when a new print medium is added as a target of the classification processing, which of the spectral data groups SD1 and SD2 the spectral data of the added print medium is closest to. As the representative points G1 and G2, points other than the center of gravity may be used. For example, regarding a plurality of pieces of spectral data belonging to one group, an average value of the maximum value and the minimum value of the reflectance at each wavelength may be calculated, and spectral data having the average values may be used as the representative points.

In the present embodiment, the plurality of pieces of spectral data are grouped into the two spectral data groups SD1 and SD2. Alternatively, the number of the spectral data groups may be only one, or three or more. A plurality of spectral data groups may be created according to a method other than the clustering processing. However, if the plurality of pieces of spectral data are grouped by the clustering processing, the pieces of spectral data approximate to each other can be grouped into the same group. When learning of a plurality of machine learning models is executed using such a plurality of spectral data groups, the accuracy of the classification processing according to the machine learning models can be improved as compared with a case in which the clustering processing is not executed.

Even when spectral data of a new print medium is added after grouping executed by the clustering processing, it is possible to maintain a state equivalent to a state in which grouping is executed by the clustering processing.

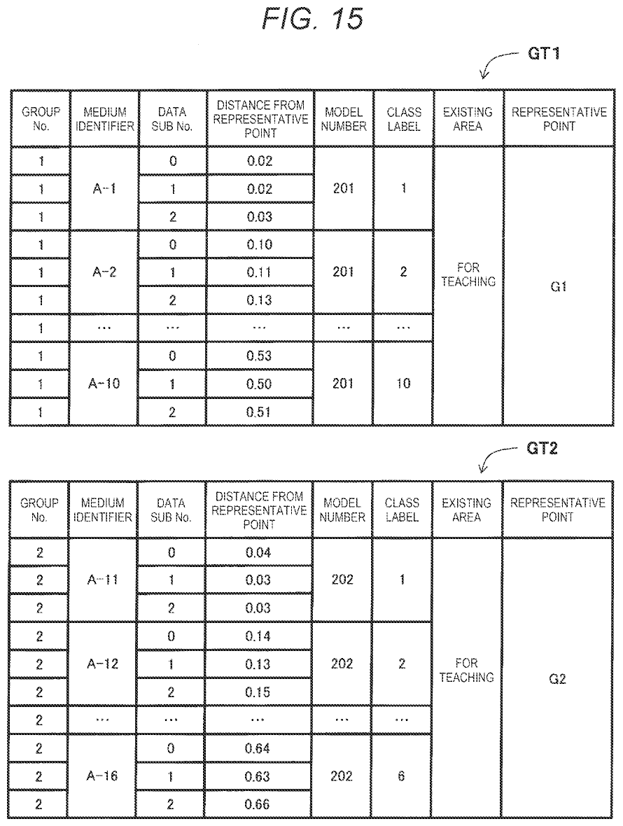

In step S350 in FIG. 11, the group management tables GT1 and GT2 are created. FIG. 15 is an explanatory diagram illustrating the group management tables GT1 and GT2. In the records of the group management tables GT1 and GT2, a group number, the medium identifier, the data sub-number, a distance from a representative point, a model number, a class label, an existing area, and coordinates of the representative point are registered for one piece of spectral data. The group number is a number for distinguishing the plurality of group management tables GT1 and GT2. The medium identifier and the data sub-number are used to distinguish the pieces of spectral data, similarly to the medium identifier list IDL described with reference to FIG. 12. The model number is a number for identifying a machine learning model that executes learning using the spectral data group of the group. Here, the symbols “201” and “202” of the two machine learning models 201 and 202 illustrated in FIGS. 9 and 10 are used as the model number. The “class label” is a value corresponding to a result of the classification processing according to the machine learning model, and is also used as a label when the spectral data is used as the teaching data. The model number and the class label are set for each medium identifier. The “existing area” indicates to which of a teaching area and a retracting area the spectral data belongs. The “teaching area” means that the spectral data is actually used for learning of the machine learning model. The “retracting area” means that the spectral data is not used for learning of the machine learning model and is in a state of being retracted from the teaching area. In the preparation step, all pieces of the spectral data are used for learning of the machine learning model, and thus belong to the teaching area.

In step S360 in FIG. 11, the user creates a machine learning model to be used for the classification processing, and sets parameters of the machine learning model. In the present embodiment, the two machine learning models 201 and 202 illustrated in FIGS. 9 and 10 are created and parameters thereof are set. Alternatively, in step S360, only one machine learning model may be created, or three or more machine learning models may be created. In step S370, the classification processing unit 114 executes learning of the machine learning models 201 and 202 using the spectral data groups SD1 and SD2. When the learning is completed, the learned machine learning models 201 and 202 are saved in the storage unit 120.

In step S380, the classification processing unit 114 reinputs the spectral data groups SD1 and SD2 to the learned machine learning models 201 and 202 to generate the known feature spectrum groups KS1 and KS2. The known feature spectrum groups KS1 and KS2 are sets of feature spectra described below. Hereinafter, a method for generating the known feature spectrum group KS1 associated with the machine learning model 201 will be mainly described.

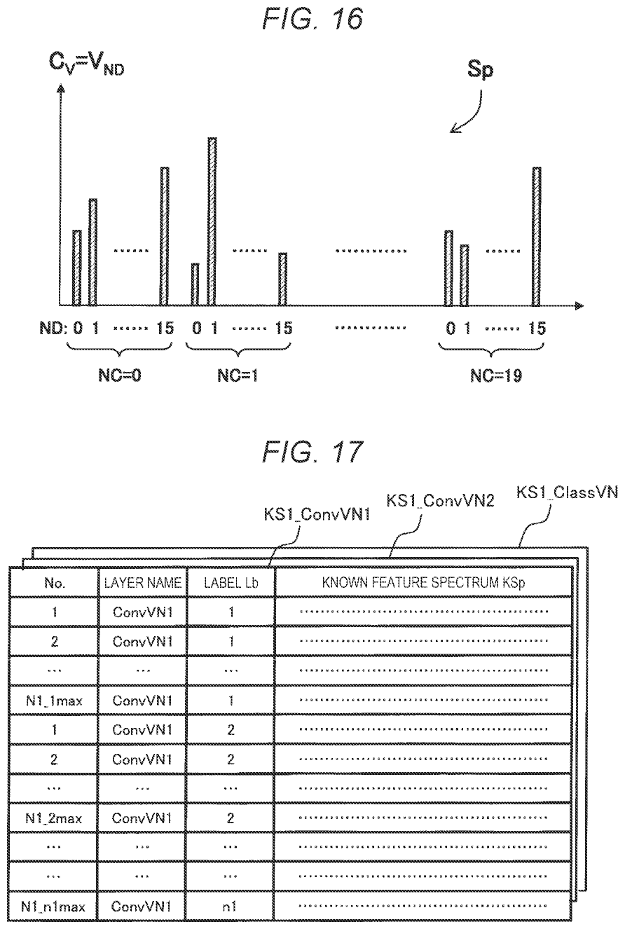

FIG. 16 is an explanatory diagram illustrating a feature spectrum Sp acquired by inputting any input data to the learned machine learning model 201. Here, the feature spectrum Sp acquired based on the output of the ConvVN1 layer 231 will be described. A horizontal axis in FIG. 16 indicates a spectral position represented by a combination of an element number ND of the output vector of the node at one planar position (x, y) of the ConvVN1 layer 231 and a channel number NC. In the present embodiment, since the vector dimension of the node is 16, the element number ND of the output vector is 16 from 0 to 15. Since the number of channels of the ConvVN1 layer 231 is 20, the channel number NC is 20 from 0 to 19.

A vertical axis in FIG. 16 indicates a feature value CV at each spectral position. In this example, the feature value CV is a value VND of each element of the output vector. Alternatively, as the feature value CV, a value acquired by multiplying the value VND of each element of the output vector by an activation value to be described later may be used, or the activation value may be used as it is. In the latter case, the number of the feature values CV included in the feature spectrum Sp is equal to the number of channels and is 20. The activation value is a value corresponding to a vector length of the output vector of the node.

Since the number of the feature spectra Sp acquired based on the output of the ConvVN1 layer 231 for one piece of input data is equal to the number of the planar position (x, y) of the ConvVN1 layer 231, the number of the feature spectra Sp is 1×6=6.

Similarly, for one piece of input data, three feature spectra Sp are acquired based on the output of the ConvVN2 layer 241, and one feature spectrum Sp is acquired based on the output of the ClassVN layer 251.

When the teaching data is reinput to the learned machine learning model 201, the similarity calculation unit 261 calculates the feature spectrum Sp illustrated in FIG. and registers the feature spectrum Sp in the known feature spectrum group KS1.

FIG. 17 is an explanatory diagram illustrating a configuration of the known feature spectrum group KS1. In this example, the known feature spectrum group KS1 includes a known feature spectrum group KS1_ConvVN1 acquired based on the output of the ConvVN1 layer 231, a known feature spectrum group KS1_ConvVN2 acquired based on the output of the ConvVN2 layer 241, and a known feature spectrum group KS1_ConvVN acquired based on the output of the ClassVN layer 251.

The records of the known feature spectrum group KS1_ConvVN1 include a record number, a layer name, a label Lb, and a known feature spectrum KSp. The known feature spectrum KSp is the same as the feature spectrum Sp in FIG. 16 acquired according to the input of the teaching data. In the example in FIG. 17, by inputting the spectral data group SD1 to the learned machine learning model 201, the known feature spectrum KSp associated with the value of the label Lb is generated and registered based on the output of the ConvVN1 layer 231. For example, N1_1max known feature spectra KSp are registered in association with the label Lb=1, N1_2max known feature spectra KSp are registered in association with the label Lb=2, and N1_n1max known feature spectra KSp are registered in association with the label Lb=n1. Each of N1_1max, N1_2max, and N1_n1max is an integer of 2 or more. As described above, the labels Lb correspond to known classes different from each other. Therefore, it can be understood that the known feature spectra KSp in the known feature spectrum group KS1_ConvVN1 are registered in association with one class among a plurality of known classes. The same applies to the other known feature spectrum groups KS1_ConvVN2 and KS1_ConvVN.

The spectral data group used in step S380 does not need to be the same as the plurality of spectral data groups SD1 and SD2 used in step S370. Also in step S380, if a part or all of the plurality of spectral data groups SD1 and SD2 used in step S370 are used, there is an advantage that it is not necessary to prepare new teaching data. Step S380 may be omitted.

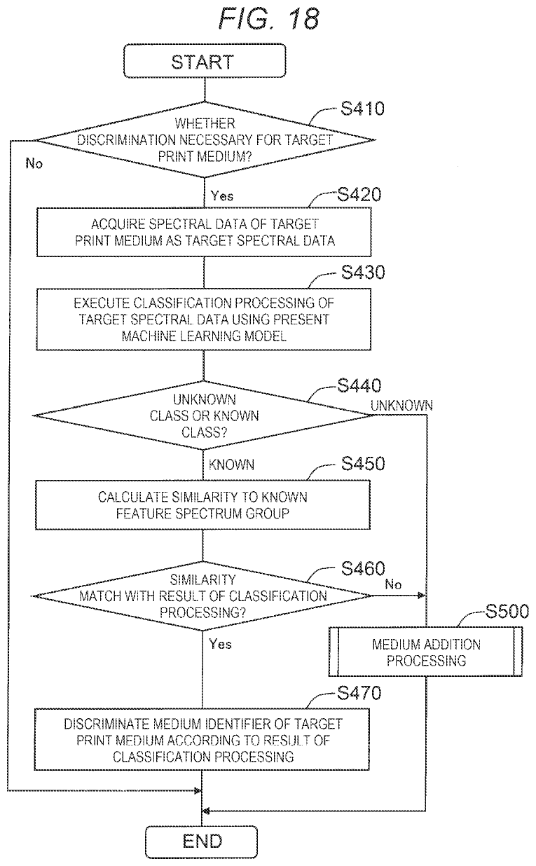

FIG. 18 is a flowchart illustrating a processing procedure of the medium type discrimination step (step S40) using the learned machine learning model. The processing here is executed by, for example, a user who uses the printer 2001.

In step S410, it is determined whether the discrimination processing is necessary for a target print medium which is a print medium to be processed. When the discrimination processing is unnecessary, that is, when the type of the target print medium is known, the processing ends. On the other hand, when the type of the target print medium is unknown and the discrimination processing is necessary, the processing proceeds to step S420.

In step S420, the classification processing unit 114 causes the spectral analyzer 31 to execute spectral measurement of the target print medium to acquire target spectral data. The target spectral data is to be subjected to the classification processing according to the machine learning model.

In step S430, the classification processing unit 114 inputs the target spectral data to the present learned machine learning models 201 and 202, and executes the classification processing of the target spectral data. In this case, it is possible to use either a first processing method of sequentially using the plurality of machine learning models 201 and 202 one by one or a second processing method of simultaneously using the plurality of machine learning models 201 and 202. In the first processing method, first, the classification processing is executed using one machine learning model 201. As a result, when it is determined that the target spectral data belongs to an unknown class, the classification processing is executed using another machine learning model 202. In the second processing method, the two machine learning models 201 and 202 are simultaneously used to execute classification processing on the same target spectral data in parallel, and the classification processing unit 114 integrates processing results. According to an experiment conducted by the inventor of the present disclosure, the second processing method is more preferable than the first processing method since the processing time of the second processing method is shorter than the processing time of the first processing method.

In step S440, the classification processing unit 114 determines, based on the result of the classification processing in step S430, whether the target spectral data belongs to an unknown class or a known class. When the target spectral data belongs to an unknown class, the target print medium is a new print medium that neither corresponds to the plurality of initial print media used in the preparation step nor corresponds to the print medium added in the medium addition processing to be described later. Therefore, the processing proceeds to step S500 to be described later and the medium addition processing is executed. On the other hand, when the target spectral data belongs to a known class, the processing proceeds to step S450.

In step S450, the similarity to the known feature spectrum group is calculated using one machine learning model, in which it is determined that the target spectral data belongs to a known class, of the plurality of machine learning models 201 and 202. For example, when it is determined, by the processing of the first machine learning model 201, that the target spectral data belongs to a known class, the similarity calculation unit 261 calculates the similarities S1_ConvVN1, S1_ConvVN2, and S1_ClassVN to the known feature spectrum group KS1 based on the outputs of the ConvVN1 layer 231, the ConvVN2 layer 241, and the ClassVN layer 251. On the other hand, when it is determined, by the processing of the second machine learning model 202, that the target spectral data belongs to a known class, the similarity calculation unit 262 calculates similarities S2_ConvVN1, S2_ConvVN2, and S2_ClassVN to the known feature spectrum group KS2.

Hereinafter, a method for calculating the similarity S1_ConvVN1 based on the output of the ConvVN1 layer 231 of the first machine learning model 201 will be described.

The similarity S1_ConvVN1 can be calculated using, for example, the following equation.

S1_ConvVN1(Class)=max[G{Sp(i,j),KSp(Class,k)}]

Here, “Class” indicates an ordinal number for a plurality of classes, G{a, b} indicates a function for calculating the similarity between a and b, Sp(i, j) indicates a feature spectrum at all planar positions (i, j) acquired according to the target spectral data, KSp(Class, k) indicates all known feature spectra associated with the ConvVN1 layer 231 and a specific “Class”, and max[X] indicates a logical operation taking the maximum value of X. That is, the similarity S1_ConvVN1 is the maximum value of the similarities calculated between the feature spectra Sp(i, j) at all the planar positions (i, j) of the ConvVN1 layer 231 and all the known feature spectra KSp(k) corresponding to a specific class. Such a similarity S1_ConvVN1 is calculated for each of a plurality of classes corresponding to a plurality of labels Lb. The similarity S1_ConvVN1 represents the degree of similarity of the target spectral data to the feature of each class.

The similarities S1_ConvVN2 and S1_ClassVN related to the outputs of the ConvVN2 layer 241 and the ClassVN layer 251 are also generated similarly to the similarity S1_ConvVN1. Although it is not necessary to generate all of the three similarities S1_ConvVN1, S1_ConvVN2, and S1_ClassVN, it is preferable to generate one or more of the similarities. In the present disclosure, the layer used to generate the similarity is also referred to as a “specific layer”.

In step S460, the classification processing unit 114 presents the similarity acquired in step S450 to the user, and the user checks whether the similarity matches with the result of the classification processing. Since the similarities S1_ConvVN1, S1_ConvVN2, and S1_ClassVN represent the degree of similarity of the target spectral data to the feature of each class, the quality of the result of the classification processing can be checked based on at least one of the similarities S1_ConvVN1, S1_ConvVN2, and S1_ClassVN. For example, when at least one of the three similarities S1_ConvVN1, S1_ConvVN2, and S1_ClassVN is not consistent with the result of the classification processing, it can be determined that the two do not match with each other. In another embodiment, when none of the three similarities S1_ConvVN1, S1_ConvVN2, and S1_ClassVN is consistent with the result of the classification processing, it may be determined that the two do not match with each other. In general, when a predetermined number of similarities among the plurality of similarities generated based on the outputs of the plurality of specific layers are not consistent with the result of the classification processing, it may be determined that the two do not match with each other. The determination in step S460 may be executed by the classification processing unit 114. Step S450 and step S460 may be omitted.

When the similarity matches with the result of the classification processing, the processing proceeds to step S470, and the classification processing unit 114 discriminates the medium identifier of the target print medium according to the result of the classification processing. The processing is executed, for example, with reference to the group management tables GT1 and GT2 illustrated in FIG. 15.

In step S460 described above, when it is determined that the similarity does not match with the result of the classification processing, the target print medium is a new print medium that neither corresponds to the plurality of initial print media used in the preparation step nor corresponds to the print medium added in the medium addition processing to be described below, and thus the processing proceeds to step S500 to be described below. In step S500, the medium addition processing is executed in order to set a new print medium as a target of the classification processing. Since the update or addition of the machine learning model is executed in the medium addition processing, it can be considered that the medium addition processing is a part of the step of preparing the machine learning model.

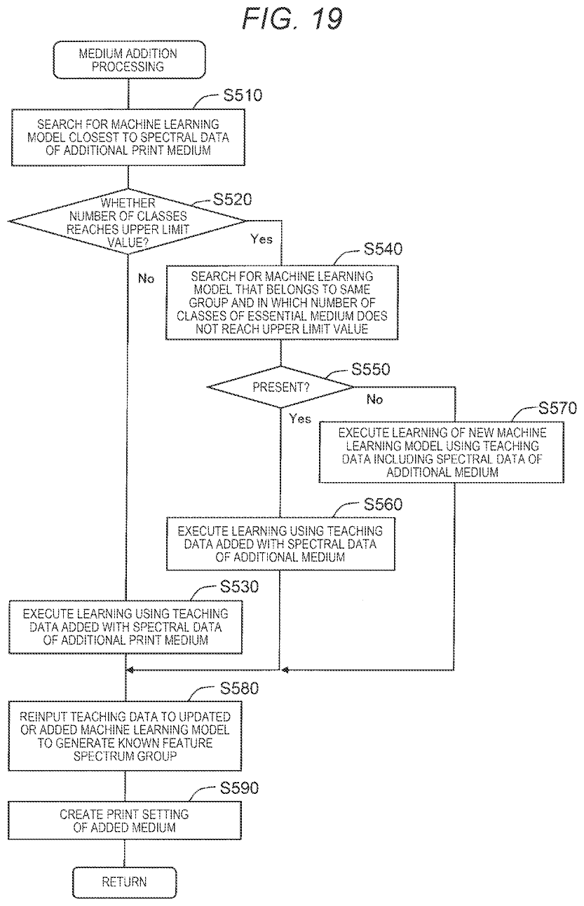

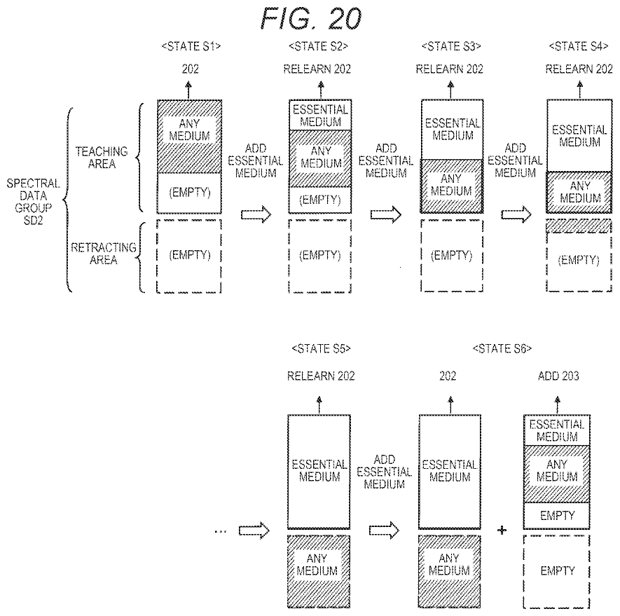

FIG. 19 is a flowchart illustrating a processing procedure of the medium addition processing. FIG. 20 is an explanatory diagram illustrating a management state of a spectral data group in the medium addition processing. In the following description, a new print medium to be added as a target of the classification processing is referred to as an “additional print medium” or an “additional medium”.

In step S510, the classification processing unit 114 searches for a machine learning model closest to the spectral data of the additional print medium from the present machine learning models 201 and 202. The “machine learning model closest to the spectral data of the additional print medium” means a machine learning model having the smallest distance between the spectral data of the additional print medium and the representative points G1 and G2 of the teaching data group used for learning of the machine learning models 201 and 202. The distances between the representative points G1 and G2 and the spectral data of the additional print medium can be calculated as, for example, a Euclidean distance. The teaching data group having the smallest distance from the spectral data of the additional print medium is also referred to as a “proximity teaching data group”.

In step S520, the classification processing unit 114 determines whether the number of classes corresponding to the essential print medium reaches the upper limit value for the machine learning model searched in step S510. As described above, in the present embodiment, all the initial print media used in the preparation step are any print media, and all the print media added after the preparation step are essential print media. When the number of classes corresponding to the essential print medium does not reach the upper limit value, the processing proceeds to step S530, and the learning of the machine learning model is executed using the teaching data to which the spectral data of the additional print medium is added. A state S1 in FIG. 20 indicates a state of the spectral data group SD2 used for learning of the machine learning model 202 in the above-described preparation step, and a state S2 indicates a state in which the spectral data of the additional print medium is added as the spectral data of the essential print medium in step S330. In FIG. 20, “any medium” means spectral data of any print medium used in the preparation step, and the “essential medium” means the spectral data of the essential print medium added by the medium addition processing in FIG. 19. The “teaching area” means that the spectral data is teaching data actually used for learning of the machine learning model. The “retracting area” means that the spectral data is not used for learning of the machine learning model and is in a state of being retracted from the teaching area. A state in which there is an empty in the teaching area means that the number of classes of the machine learning model 202 does not reach the upper limit value. Since in the state S1, the number of classes corresponding to the essential print medium does not reach the upper limit value in the machine learning model 202, the spectral data of the additional print medium is added to the teaching area and is in the state S2, and relearning of the machine learning model 202 is executed using the spectral data belonging to the teaching area as the teaching data. In the relearning, only the added spectral data may be used as the teaching data.

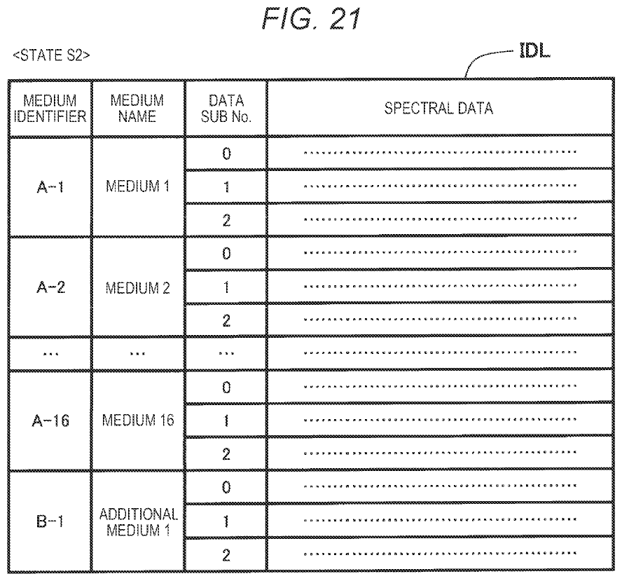

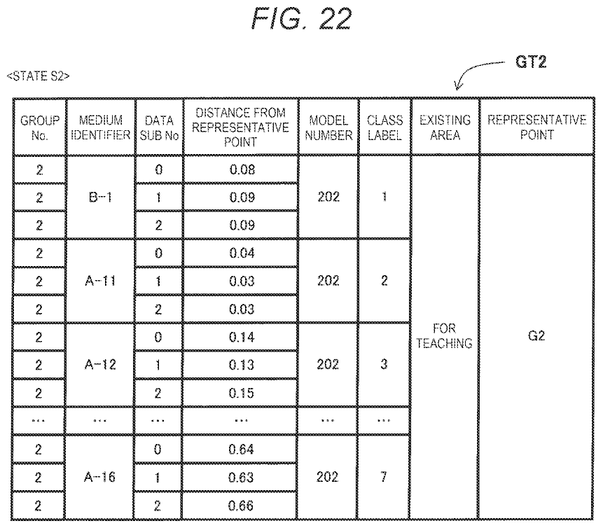

FIG. 21 illustrates the medium identifier list IDL in the state S2 in FIG. 20. FIG. 22 illustrates the group management table GT2 for the second spectral data group SD2 in the state S2. In the medium identifier list IDL, “B-1” is assigned as the medium identifier of the added print medium, and the medium name and the spectral data of the added print medium are registered. Regarding the spectral data of the additional print medium, it is also preferable that a plurality of pieces of spectral data are generated by executing data expansion to give random variations to the measured spectral data. Also in the group management table GT2, a plurality of pieces of spectral data are registered for the added print medium having the medium identifier B-1. The representative point G2 related to the teaching data group in the second spectral data group SD2 is recalculated including the added spectral data.

When a print medium is further added from the state S2 in FIG. 20, the state shifts to a state S3, a state S4, and a state S5. In the state S2 to the state S4, similarly to the state S1, since the number of classes corresponding to the essential print medium does not reach the upper limit value in the machine learning model 202, step S530 is executed, the spectral data of the additional print medium is added to the teaching area, and the relearning of the machine learning model 202 is executed. In the state S3, the sum of the number of classes corresponding to the essential print medium and the number of classes corresponding to any print medium reaches the upper limit value in the machine learning model 202, and there is no empty in the teaching area. Therefore, when the state S3 is transitioned to the state S4, in step S530, the spectral data of the additional print medium, which is the essential print medium, is added to the teaching area, and the spectral data of any print medium is deleted from the teaching area. The deleted spectral data is retracted in the retracting area. The reason why the spectral data is retracted in the retracting area is to allow the spectral data to be reused. As the spectral data of any print medium to be retracted from the teaching area to the retracting area, it is preferable to select the spectral data having the largest distance from the representative point of the teaching data group. Accordingly, the distance between the pieces of teaching data can be reduced, and thus the accuracy of the classification processing can be improved.

In the state S5 in FIG. 20, the number of classes corresponding to the essential print medium reaches the upper limit value in the machine learning model 202. In this case, the processing proceeds from step S520 to step S540. In step S540, the classification processing unit 114 searches for a machine learning model that belongs to the same group as the machine learning model searched for in step S510 and in which the number of classes corresponding to the essential print medium does not reach the upper limit value. When such a machine learning model is present, the processing proceeds from step S550 to step S560, and the learning of the machine learning model is executed using the teaching data to which the spectral data of the additional print medium is added. The processing is the same as the processing in step S530 described above.

When no machine learning model is found by the search in step S540, the processing proceeds from step S550 to step S570, a new machine learning model is created, and the learning of the new machine learning model is executed using the teaching data including the spectral data of the additional print medium. The processing corresponds to the processing of changing from the state S5 to a state S6 in FIG. 20. In the state S5, the number of classes corresponding to the essential print medium reaches the upper limit value in the machine learning model 202, and no other machine learning model belonging to the same group is present. Therefore, by the processing in step S570, as illustrated in the state S6, a new machine learning model 203 is created, and the learning of the new machine learning model is executed using the teaching data including the spectral data of the additional print medium which is a new essential print medium. At this time, since only the spectral data of the additional print medium is insufficient as the teaching data, the spectral data of one or more of any print media retracted in the retracting area is also used as the teaching data. Accordingly, the accuracy of the classification processing according to the new machine learning model 203 can be improved.

The above steps S540 to S560 may be omitted, and when the number of classes of the essential print medium is equal to the upper limit value in step S520, the processing may immediately proceed to step S570.

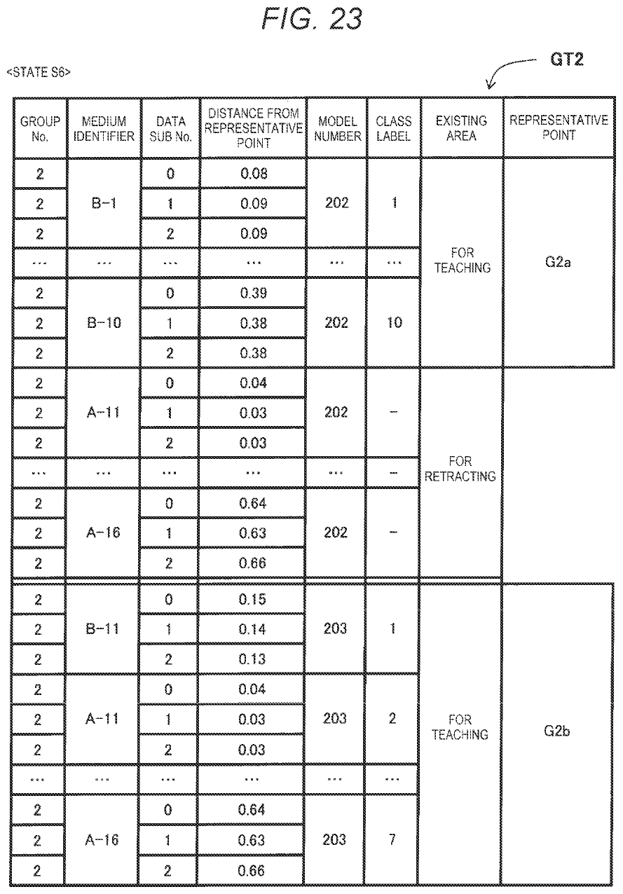

FIG. 23 illustrates the group management table GT2 for the second group in the state S6. The spectral data of the print media having the medium identifiers A-11 to A-16 is the spectral data of any print medium used in the preparation step. The spectral data of the print media having the medium identifiers B-1 to B-11 are the spectral data of the essential print medium added after the preparation step. In the group management table GT2, states of the spectral data of two machine learning models 202 and 203 belonging to the same group are registered. Regarding the machine learning model 202, spectral data related to ten added essential print media is accommodated in the teaching area, and spectral data related to six of any print media is retracted in the retracting area. Regarding the machine learning model 203, spectral data related to one essential print medium and spectral data related to six of any print media are accommodated in the teaching area, and the retracting area is empty. Representative points G2a and G2b of the teaching data group of the machine learning models 202 and 203 are calculated using the spectral data accommodated in each teaching area.

The medium addition processing illustrated in FIG. can also be executed when the number of the present machine learning models is one. A case in which the number of the present machine learning models is one is, for example, a case in which the second machine learning model 202 illustrated in FIG. 10 is not prepared and the processing in FIG. 18 is executed using only the first machine learning model 201 illustrated in FIG. 9. In this case, the processing in step S370 in FIG. 11 is the processing of adding the second machine learning model 202 as a new machine learning model. As described above, in the classification processing executed using only the first machine learning model 201, the processing of adding the second machine learning model 202 as a new machine learning model when it is determined that the input data belongs to an unknown class can be understood as an example of the processing of preparing the two machine learning models 201 and 202.

When the machine learning model is updated or added in any one of steps S530, S560, and S570, in step S580, the classification processing unit 114 reinputs the teaching data to the updated or added machine learning model to generate a known feature spectrum group. The processing is the same as the processing in step S430 in FIG. 18, and thus the description thereof will be omitted. In step S590, the print setting creating unit 116 creates the print setting of the added target print medium. The processing is the same as the processing in step S330 in FIG. 11, and thus the description thereof will be omitted.

When the processing in FIG. 19 is completed, the processing in FIG. 18 is also completed. Thereafter, the processing in FIG. 18 is reexecuted at any timing.

In the processing in FIG. 19 described above, the processing in step S510 corresponds to the processing of selecting a proximity teaching data group having a representative point closest to the spectral data of the additional print medium among N teaching data groups used for learning of the N machine learning models, and selecting a specific machine learning model for which learning is executed using the proximity teaching data group. By executing such processing, even when the spectral data of the additional print medium is added to the proximity teaching data group, the teaching data group after the addition can be maintained in a state equivalent to a state of being grouped by the clustering processing. As a result, the accuracy of the classification processing according to the machine learning model can be improved.

According to the processing in FIG. 19, it is possible to add a new print medium to the target of the classification processing. On the other hand, it is also possible to exclude the print medium from the target of the classification processing in response to an instruction of the user.

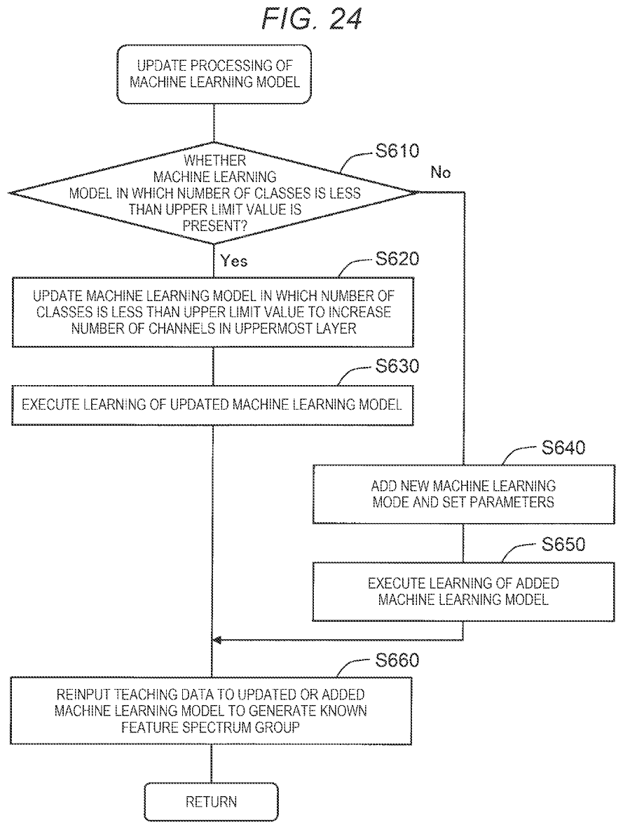

FIG. 24 is a flowchart illustrating a processing procedure of update processing of the machine learning model.

In step S610, it is determined whether a machine learning model is present in which the number of classes is less than the upper limit value among the present machine learning models. When N is an integer of 2 or more and N present machine learning models are present, it is determined whether a machine learning model is present in which the number of classes is less than the upper limit value among the present machine learning models.

Alternatively, the number N of the present machine learning models may be one. In the present embodiment, two present machine learning models 201 and 202 illustrated in FIGS. 9 and 10 are present, the number of classes of the first machine learning model 201 is equal to the upper limit value, and the number of classes of the second machine learning model 202 is less than the upper limit value. When no machine learning model is present in which the number of classes is less than the upper limit value among the present machine learning models, the processing proceeds to step S640 to be described later, and a new machine learning model is added. On the other hand, when a machine learning model is present in which the number of classes is less than the upper limit value, the processing proceeds to step S620, and the machine learning model is updated.

In step S620, the classification processing unit 114 updates the machine learning model in which the number of classes is less than the upper limit value to increase the number of channels in the uppermost layer by one. In the present embodiment, the number (n2+1) of channels in the uppermost layer of the second machine learning model 202 is changed from 3 to 4. In step S630, the classification processing unit 114 executes the learning of the machine learning model updated in step S620. At the time of the learning, the target spectral data acquired in step S420 in FIG. 18 is used as new teaching data together with the teaching data group TD2 for the second machine learning model 202 used so far. The new teaching data is preferably a plurality of pieces of other spectral data acquired based on the spectral measurement of the same print medium PM in addition to the target spectral data acquired in step S420. Therefore, the spectral analyzer 31 preferably acquires the spectral data at each of a plurality of positions of one print medium PM. When the learning is completed, the updated machine learning model 202 has a known class corresponding to the target spectral data. Therefore, it is possible to recognize the type of the print medium PM using the updated machine learning model 202.

In step S640, the classification processing unit 114 adds a new machine learning model having a class corresponding to the target spectral data, and sets a parameter of the new machine learning model. The new machine learning model preferably has the same configuration as that of the first machine learning model 201 illustrated in FIG. 9 except for the number of channels in the uppermost layer. The new machine learning model preferably has, for example, two or more known classes, similarly to the second machine learning model 202 illustrated in FIG. 10. One of the two or more known classes is a class corresponding to the target spectral data. At least one of the two or more known classes is preferably the same as at least one known class of the present machine learning model. Setting one class of the new machine learning model to be the same as the known class of the present machine learning model is achieved by executing the learning of the new machine learning model using the same teaching data as the teaching data used for learning of the present machine learning model for the known class. The reason why two or more known classes are provided in the new machine learning model is that, if only one known class is provided, the learning may not be executed with sufficient accuracy.

The class of the present machine learning model adopted as a new machine learning model is preferably, for example, selected from the following classes.

(a) a class corresponding to optical spectrum data having the highest similarity to the target spectral data among a plurality of known classes in the present machine learning model

(b) a class corresponding to optical spectrum data having the lowest similarity to the target spectral data among the plurality of known classes in the present machine learning model

(c) a class erroneously discriminated as a class to which the target spectral data belongs in step S440 in FIG. among the plurality of known classes in the present machine learning model

If the class (a) or (c) is adopted, erroneous discrimination in a new machine learning model can be reduced. If the class (b) is adopted, it is possible to shorten the learning time of a new machine learning model.

In step S650, the classification processing unit 114 executes the learning of the added machine learning model. In the learning, the target spectral data acquired in step S420 in FIG. 18 is used as new teaching data. The new teaching data is preferably a plurality of pieces of other spectral data acquired based on the spectral measurement of the same print medium PM in addition to the target spectral data acquired in step S420. When one or more classes of the new machine learning model are the same as the known classes of the present machine learning model, the teaching data used for learning of the present machine learning model for the known classes is also used.

When the number of known classes of the second machine learning model 202 reaches the upper limit value, the third machine learning model is added in steps S640 and S650 in FIG. 24. The same applies to the fourth and subsequent machine learning models. As described above, in the present embodiment, when N is an integer of 2 or more, (N−1) machine learning models have the number of classes equal to the upper limit value, and the other one machine learning model has the number of classes equal to or less than the upper limit value. When it is determined that the target spectral data belongs to an unknown class when the classification processing is executed on the target spectral data using the N machine learning models, any one piece of the following processing is executed.

(1) When the other one machine learning model has the number of classes less than the upper limit value, a new class for the target spectral data is added by executing learning using the teaching data including the target spectral data for the other one machine learning model by the processing in steps S620 and S630.

(2) When the other one machine learning model has the same number of classes as the upper limit value, a new machine learning model having a class corresponding to the target spectral data is added by the processing in steps S640 and S650.

According to the processing, even when the class classification of the target spectral data is not successfully executed according to the N machine learning models, it is possible to execute the classification into the class corresponding to the target spectral data.

The update processing of the machine learning model illustrated in FIG. 24 can also be executed when the number of the present machine learning model is one. A case in which the number of the present machine learning models is one is, for example, a case in which the second machine learning model 202 illustrated in FIG. 10 is not prepared and the processing in FIG. 18 is executed using only the first machine learning model 201 illustrated in FIG. 9. In this case, steps S640 and S650 in FIG. 24 are processing for adding the second machine learning model 202 as a new machine learning model. As described above, in the classification processing executed using only the first machine learning model 201, the processing of adding the second machine learning model 202 as a new machine learning model when it is determined that the input data belongs to an unknown class can be understood as an example of the processing of preparing the two machine learning models 201 and 202.

In step S660, the classification processing unit 114 reinputs the teaching data to the updated or added machine learning model to generate a known feature spectrum group.

As described above, in the present embodiment, when N is an integer of 2 or more, the classification processing is executed using N machine learning models. Therefore, the processing can be executed at a higher speed as compared with a case in which classification processing into a large number of classes is executed according to one machine learning model. When the classification of the data to be classified cannot be successfully executed according to the present machine learning model, it is possible to execute classification into the class corresponding to the data to be classified by adding a class to the present machine learning model or adding a new machine learning model.

In the above description, a vector neural network type machine learning model using vector neurons is used. Alternatively, a machine learning model using scalar neurons, such as a normal convolutional neural network, may be used instead. However, the vector neural network type machine learning model is preferable in that the accuracy of the classification processing according to the vector neural network type machine learning model is higher than that according to the machine learning model using scalar neurons.

A method of calculating the output of each layer in the first machine learning model 201 illustrated in FIG. 9 is as follows. The same applies to the second machine learning model 202.

Regarding each node of the PrimeVN layer 221, scalar outputs of 1×1×32 nodes of the Conv layer 211 is regarded as a 32-dimensional vector, and the vector is multiplied by a transformation matrix to acquire a vector output of the node. The transformation matrix is an element of a 1×1 kernel, and is updated by the learning of the machine learning model 201. The processing of the Conv layer 211 and the PrimeVN layer 221 can be integrated to form one primary vector neuron layer.

When the PrimeVN layer 221 is referred to as a “lower layer L” and the ConvVN1 layer 231 adjacent to the upper side of the PrimeVN layer 221 is referred to as an “upper layer L+1”, the output of each node of the upper layer L+1 is determined using the following equations.

$$\begin{matrix}{v}_{ij} = {W}_{ij}^{L} {M}_{i}^{L} & ( 2 ) \\ {u}_{j} = {Σ}_{i} {v}_{ij} & ( 3 ) \\ {a}_{j} = F ( ‖ {u}_{j} ‖ ) & ( 4 ) \\ {M}_{j}^{L + 1} = {a}_{j} \times \frac{1}{‖ {u}_{j} ‖} {u}_{j} & ( 5 )\end{matrix}$$

Here, MLi is an output vector of an i-th node in the lower layer L, ML+1j is an output vector of the j-th node in the upper layer L+1, vij is a prediction vector of the output vector ML+1j, WLij is a prediction matrix for calculating the prediction vector vij based on the output vector MLi of the lower layer L, uj is the sum of the prediction vectors vij, that is, a sum vector which is a linear combination, aj is an activation value which is a normalization factor acquired by normalizing the norm |uj| of the sum vector uj, and F(X) is a normalization function for normalizing X.

As the normalization function F(X), for example, the following equation (4a) or equation (4b) can be used.

$$\begin{matrix}{a}_{j} = F ( ‖ {u}_{j} ‖ ) = softmax ( ‖ {u}_{j} ‖ ) = \frac{exp ( β ‖ {u}_{j} ‖ )}{{Σ}_{k} exp ( β ‖ {u}_{k} ‖ )} & ( 4 a ) \\ {a}_{j} = F ( ‖ {u}_{j} ‖ ) = \frac{‖ {u}_{j} ‖}{{Σ}_{k} ‖ {u}_{k} ‖} & ( 4 b )\end{matrix}$$

Here, k is an ordinal number for all nodes of the upper layer L+1, and β is an adjustment parameter which is any positive factor, and for example, β=1.

In the above equation (4a), the activation value aj is acquired by normalizing the norm |uj| of the sum vector uj with the softmax function for all the nodes of the upper layer L+1. On the other hand, in the equation (4b), the activation value aj is acquired by dividing the norm |uj| of the sum vector uj by the sum of the norms |uj| of all the nodes in the upper layer L+1. The normalization function F(X) may be a function other than the equation (4a) and the equation (4b).

The ordinal number i in the above equation (3) is assigned to the node of the lower layer L used to determine the output vector ML+1j of the j-th node in the upper layer L+1 for convenience, and takes values of 1 to n. The integer n is the number of nodes in the lower layer L used to determine the output vector ML+1j of the j-th node in the upper layer L+1. Therefore, the integer n is given according to the following equation.

n=Nk×Nc (6)

Here, Nk is the number of elements of the kernel, and Nc is the number of channels of the PrimeVN layer 221 which is the lower layer. In the example in FIG. 9, since Nk=3 and Nc=26, n=78.

One kernel used to obtain the output vector of the ConvVN1 layer 231 has 1×3×26=78 elements in which the kernel size is 1×3 as the surface size and the number of channels of the lower layer is 26 as the depth, and each of these elements is the prediction matrix WLij. In order to generate the output vectors of 20 channels of the ConvVN1 layer 231, 20 sets of the kernels are required. Therefore, the number of prediction matrices WLij of the kernel used to calculate the output vector of the ConvVN1 layer 231 is 78×20=1560. These prediction matrices WLij are updated by the learning of the machine learning model 201.

As can be seen from the above equations (2) to (5), the output vector ML+1j of each node of the upper layer L+1 is calculated by the following operation.

(a) obtaining the prediction vector vij by multiplying the output vector MLi of each node of the lower layer L by the prediction matrix WLij,

(b) obtaining the sum vector uj, which is a sum of the prediction vectors vij acquired based on the nodes of the lower layer L, that is, a linear combination,

(c) obtaining the activation value aj, which is a normalization factor, by normalizing the norm |uj| of the sum vector uj, and

(d) dividing the sum vector uj by the norm |uj|, and further executing multiplying by the activation value aj.

The activation value aj is a normalization factor acquired by normalizing the norm |uj| for all nodes of the upper layer L+1. Therefore, the activation value aj can be considered as an index indicating a relative output intensity of each node among all nodes in the upper layer L+1. Each of the norms used in the equations (4), (4a), (4b), and (5) is an L2 norm representing a vector length in a typical example. At this time, the activation value aj corresponds to the vector length of the output vector ML+1j. Since the activation value aj is merely used in the above equations (4) and (5), it is not necessary to output the activation value aj from the node. Alternatively, the upper layer L+1 can output the activation value aj to the outside.

The configuration of the vector neural network is substantially the same as the configuration of the capsule network, and the vector neurons of the vector neural network correspond to capsules of the capsule network. However, the operation according to the above equations (2) to (5) used in the vector neural network is different from the operation used in the capsule network. The largest difference between the two operations is that, in the capsule network, the prediction vector vij on the right side of the above equation (3) is multiplied by a weight, and the weight is searched by repeating dynamic routing a plurality of times. On the other hand, in the vector neural network according to the present embodiment, the output vector ML+1j is acquired by sequentially calculating the above equations (2) to (5) once. Therefore, there is an advantage that it is not necessary to repeat the dynamic routing and the operation is executed at a higher speed. The vector neural network according to the present embodiment has an advantage that, the memory amount required for the operation is smaller than that of the capsule network, and according to the experiment of the inventor of the present disclosure, the memory amount of the vector neural network is only approximately ½ to ⅓ of that of the capsule network.

The vector neural network is the same as the capsule network in that a node that inputs and outputs a vector is used. Therefore, the advantage of using vector neurons is also common to the capsule network. The plurality of layers 211 to 251 are the same as a normal convolutional neural network in that, the higher the level, the larger the feature of the region, and the lower the level, the smaller the feature of the region. Here, the “feature” means a characteristic portion included in input data to the neural network. A vector neural network or a capsule network is superior to a normal convolutional neural network in that an output vector of a certain node includes spatial information representing spatial information of a feature represented by the node. That is, the vector length of the output vector of a certain node represents a presence probability of the feature represented by the node, and the vector direction represents the spatial information such as the direction and the scale of the feature. Therefore, the vector directions of the output vectors of the two nodes belonging to the same layer represent positional relation of the features. Alternatively, it can be said that the vector directions of the output vectors of the two nodes represent variations of features. For example, in the case of a node corresponding to the feature of “eye”, the direction of the output vector may represent variations such as the fineness and the lifting manner of the eye. In a normal convolutional neural network, it is said that spatial information of a feature is lost due to pooling processing. As a result, the vector neural network and the capsule network have an advantage that the performance of identifying input data is superior to that of the normal convolutional neural network.

The advantage of the vector neural network can also be considered as follows. That is, the vector neural network has an advantage in that an output vector of a node expresses a feature of input data as coordinates in a continuous space. Therefore, the output vector can be evaluated such that the features are similar if the vector directions are close. There is also an advantage that, for example, even when the feature included in the input data is not covered by the teaching data, the feature can be discriminated by interpolation. On the other hand, the normal convolutional neural network has a disadvantage that, disorderly compression is applied due to the pooling processing, and thus a feature of input data cannot be expressed as coordinates in a continuous space.

The outputs of the nodes of the ConvVN2 layer 241 and the ClassVN layer 251 are also determined in the same manner using the above equations (2) to (5). Therefore, detailed description thereof will be omitted. The resolution of the ClassVN layer 251, which is the uppermost layer, is 1×1, and the number of channels is (n1+1).

The output of the ClassVN layer 251 is converted into a plurality of determination values Class 1-1 to Class 1-2 for a known class and a determination value Class 1-UN indicating an unknown class. These determination values are normally values normalized by the softmax function. Specifically, for example, a vector length of the output vector is calculated based on the output vector of each node of the ClassVN layer 251, and the vector length of each node is normalized by the softmax function. Accordingly, a determination value for each class can be acquired. As described above, the activation value aj acquired according to the above equation (4) is a value corresponding to the vector length of the output vector ML+1j, and is normalized. Therefore, the activation value aj in each node of the ClassVN layer 251 may be output and used as it is as a determination value for each class.

In the above embodiment, the machine learning models 201 and 202 are the vector neural network that obtains the output vector by the operation of the above equations (2) to (5). Alternatively, instead of the vector neural network, a capsule network disclosed in U.S. Pat. No. 5,210,798 or International Publication No. 2019/083553 may be used. Alternatively, a neural network using only scalar neurons may be used.

The method for generating the known feature spectrum groups KS1 and KS2 and the method for generating the output data of the intermediate layer such as the ConvVN1 layer are not limited to the above embodiment, and these data may be generated using, for example, the K-means method. These pieces of data may be generated using conversion of PCA, ICA, Fisher, or the like. The known feature spectrum group KSG and the output data of the intermediate layer may be converted according to different methods.

Next, a processing method in the print condition setting step (step S50) will be described.

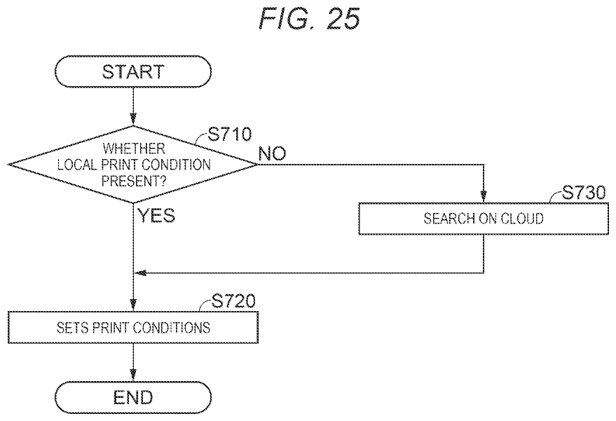

In the print condition setting step (step S50), print conditions are set according to the discriminated ink type and the discriminated medium type. FIG. 25 is a flowchart illustrating a detailed processing method in the print condition setting step (step S50).

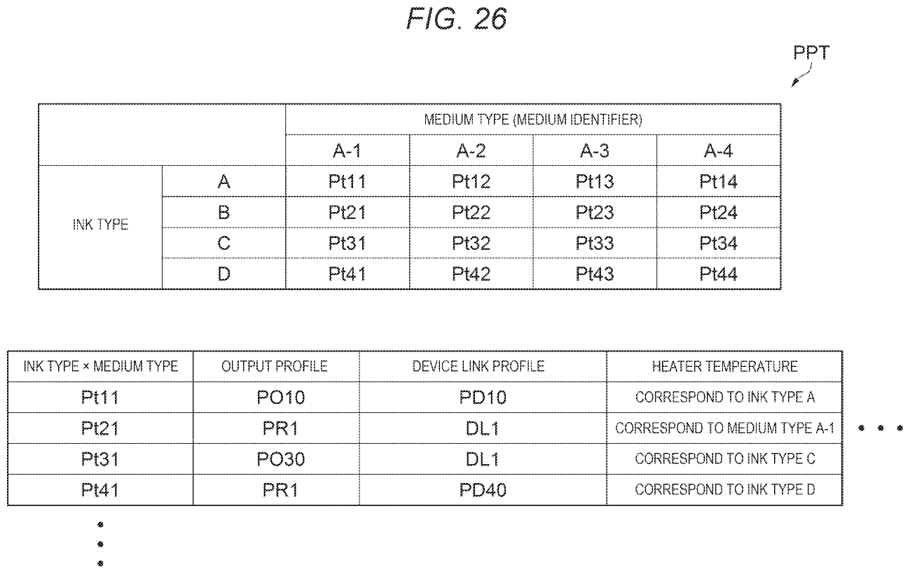

The print conditions are derived from a print condition setting table PPT (FIG. 26) stored in the storage unit 120. The print condition setting table PPT is table data in which the calculation unit 110 integrates the ink and print condition data 106 (at least one of the control parameter, the maintenance mode, the ICC profile, and the print mode) and the medium and print setting table PST (FIG. 13) and calculates the print conditions corresponding to the ink type and the medium type.

When an item is present in which the print condition is different between the ink type and the medium type, it may be set which of the print condition held by the ink type and the print condition held by the medium type is prioritized. For example, when the ink type A is combined with the medium type A-1, Pt11 is derived with reference to the print condition setting table PPT, and PO10 corresponding to the ink type A is set for the output profile, PD10 corresponding to the ink type A is set for the device link profile, and the condition corresponding to the ink type A is set for the heater temperature. When the ink type B is combined with the medium type A-1, Pt21 is derived with reference to the print condition setting table PPT, and PR1 corresponding to the medium type A-1 is set for the output profile, DL1 corresponding to the medium type A-1 is set for the device link profile, and the condition corresponding to the medium type A-1 is set for the heater temperature. Further, when the ink type C is combined with the medium type A-1, Pt31 is derived with reference to the print condition setting table PPT, and P030 corresponding to the ink type C is set for the output profile, DL1 corresponding to the medium type A-1 is set for the device link profile, and the condition corresponding to the ink type C is set for the heater temperature. Furthermore, when the ink type D is combined with the medium type A-1, Pt41 is derived with reference to the print condition setting table PPT, and PR1 corresponding to the medium type A-1 is set for the output profile, PD40 corresponding to the ink type D is set for the device link profile, and the condition corresponding to the ink type D is set for the heater temperature. The output profile, the device link profile, and the heater temperature are described as examples. The same applies to other items, and the print condition held by the ink type can be set in combination with the print condition held by the medium type.

Instead of setting the conditions associated with the ink type or the medium type, the conditions used according to a combination of a specific ink type and a specific medium type may be set.

It may be notified that items having different print conditions are present between the ink type and the medium type, and the operator or the like may select or set the conditions.

In step S710, the calculation unit 110 determines whether a local print condition is present. Specifically, it is determined whether the print condition setting table PPT corresponding to the discriminated ink type and medium type is stored in the information processing apparatus 20 (for example, a personal computer) used by the user.

When it is determined that a local print condition is present (YES), the processing proceeds to step S720, and when it is determined that no local print condition is present (NO), the processing proceeds to step S730.

In step S720, the calculation unit 110 sets print conditions based on the print condition setting table PPT. The calculation unit 110 causes the display unit 150 to display the set print conditions.

On the other hand, in step S730, the print condition is searched for on the cloud via the communication unit 130. Then, the processing proceeds to step S720, and the calculation unit 110 sets the searched print condition.

Thereafter, the print processing unit 112 executes printing according to the set print conditions.

As described above, according to the present embodiment, it is possible to discriminate the ink type and the medium type, and to set appropriate print conditions (for example, a control parameter, a maintenance mode, an ICC profile, and a print mode) according to a combination of the ink type and the medium type.

What is claimed is:

1. A print condition setting method for setting a print condition in a printer, the print condition setting method comprising:
an ink type learning step of executing machine learning of an ink type discriminator using physical property information of ink and an ink type identifier;
a medium type learning step of executing machine learning of a medium type discriminator using characteristic information of a medium and medium type identification information; and
a print condition setting step of setting the print condition according to an ink type discriminated by the ink type discriminator and a medium type discriminated by the medium type discriminator.

2. The print condition setting method according to claim 1, wherein
the print condition is a control parameter of the printer.

3. The print condition setting method according to claim 1, wherein
the print condition is a maintenance mode of the printer.

4. The print condition setting method according to claim 1, wherein
the print condition is an ICC profile of the printer.

5. The print condition setting method according to claim 1, wherein
the print condition is a recording method of the printer.

6. The print condition setting method according to claim 1, wherein
a machine learning method of the ink type discriminator in the ink type learning step is different from a machine learning method of the medium type discriminator in the medium type learning step.

7. A print condition setting system configured to set a print condition in a printer, the print condition setting system comprising:
an ink type learning unit configured to execute machine learning of an ink type discriminator using physical property information of ink and an ink type identifier;
a medium type learning unit configured to execute machine learning of a medium type discriminator using characteristic information of a medium and medium type identification information; and
a print condition setting unit configured to set the print condition according to an ink type discriminated by the ink type discriminator and a medium type discriminated by the medium type discriminator.
